(19) United States
(12) Patent Application Publication
(10) Pub. No.: US 2008/0174612 A1
(43) Pub. Date: Jul. 24, 2008

(54) Image Processor, Image Processing Method, and Image Display Device

(75) Inventors: Jun Someya, Tokyo (JP); Noritaka Okuda, Tokyo (JP)

Correspondence Address: BIRCH STEWART KOLASCH & BIRCH, PO BOX 747, FALLS CHURCH, VA, 22040-0747, US

(73) Assignee: Mitsubishi Electric Corporation, Tokyo (JP)

(21) Appl. No.: 11/885,927

(22) PCT Filed: Jul. 26, 2005
(86) PCT No.: PCT/JP05/13614

§ 371 Date: Jan. 2, 2008

(30) Foreign Application Priority Data
Mar. 10, 2005 (JP) 2005-067148
Mar. 23, 2005 (JP) 2005-084193

(51) Int. Cl. G09G 5/02; G09G 3/36

(52) U.S. Cl. 345/690; 345/89

(57) ABSTRACT

An image processing device and an image processing method according to the present invention, by dividing an image into a plurality of blocks, generates a control signal denoting a change in the image data, based on a result of comparing first encoded image data that is quantized from image data in each of the blocks based on representative values of the image data in each of the blocks with second encoded image data that is obtained by delaying the first encoded image data for a period equivalent to one frame, and generates one-frame-preceding image data by choosing on a pixel to pixel basis either the current-frame image data or second decoded image data that is obtained by decoding the second encoded image data, based on the control signal.

### FIELD OF THE INVENTION

The present invention relates mainly to image processors and image processing methods for improving response speed of liquid crystal displays and the like.

### BACKGROUND OF THE INVENTION

Liquid crystal panels, by reason of their small thickness and lightweight, have been widely used for display devices such as a television receiver, a display device for a computer, and a display section of a personal digital assistant. Since liquid crystals, however, take a certain time to reach a designated transmittance after the driving voltage is applied thereto, there has been a shortcoming in that the liquid crystals cannot respond to motion images changing quickly. In order to solve such a problem, a driving method is employed in which an overvoltage is applied to a liquid crystal so that the liquid crystal reaches a designated transmittance within one frame in a case of gray-scale values varying frame by frame (Japanese Patent Publication No. 2616652). To be more specific, comparing on a pixel to pixel basis current-frame image data with image data preceding by one frame, if a gray-scale value varies, a compensation value corresponding to the variation is added to the current-frame image data. That is, if a gray-scale value increases with respect to that preceding by one frame, a driving voltage higher than usual is applied to the liquid crystal panel, and if decreases, a voltage lower than usual is applied thereto.

In order to perform the method described above, a frame memory is required to output image data preceding by one frame. Recently, there has been a need for increasing capacity of a frame memory with increasing pixels to be displayed due to upsizing of liquid crystal panels. Moreover, since increase in the number of pixels to be displayed involves to increase the amount of data to be read from and written into a frame memory during a given period (for example, one frame period), a data transfer rate needs to be increased by increasing the clock frequency that controls the reading and writing. Such increase in capacity of frame memory and in the transfer rate leads to cost increase of liquid crystal display devices.

In order to solve such problems, the image processing circuit for driving a liquid crystal, disclosed in Japanese Laid-Open Patent Publication No. 2004-163842, reduces its frame memory capacity by encoding image data to be stored therein. By correcting image data based on a difference between decoded image data of a current frame obtained by decoding encoded image data and image data preceding by one frame obtained by decoding encoded image data delay by one frame period, unnecessary voltage caused by an encoding and decoding error, which occurs when a still image is inputted, can be prevented from being applied to the liquid crystal.

### SUMMARY OF THE INVENTION

As for a motion image, a dither processing is performed that generates pseudo-halftones by controlling an interleaving rate of frames that are added with a gray-scale by one level in the least significant bit of the image data. In the image processing circuit for driving a liquid crystal, disclosed in Japanese Laid-Open Patent Publication No. 2004-163842, image data is corrected based on a difference between decoded image data of a current frame and a previous frame. In a case image data processed as described above is inputted, if an inter-frame change in the gray-scale by one level is amplified due to an encoding and decoding error, a variation of the image data, which is detected from decoded image data, becomes large. As a result, unnecessary compensation, which applies over-voltage to liquid crystals, occurs.

The present invention has been made in light of the above-described problems, with an object of providing an image processor for driving a liquid crystal that encodes and decodes image data to reduce size of a frame memory, that correct image data accurately without being affected by an encoding and decoding error, in order to apply an appropriate compensation voltage to a liquid crystal, even in cases that image data added with pseudo gray-scale signals are inputted.

A first image processor according to the present invention that corrects and outputs image data representing a gray-scale value of each of pixels of an image, based on a change in the gray-scale value of each pixel, the image processor includes, an encoding means that divides a current-frame image into a plurality of blocks, and outputs first encoded image data, corresponding to the current-frame image, configured including a representative value denoting a magnitude of pixel data of each of the blocks, and a quantized value, quantized based on the representative value, of pixel data in each of the blocks; a decoding means that decodes the first encoded image data, to output first decoded image data corresponding to the current-frame image; a delay means that delays the first encoded image data for a period equivalent to one frame, to output second encoded image data corresponding to the image preceding the current frame by one frame; a decoding means that decodes the second encoded image data, to output second decoded image data corresponding to the image preceding the current frame by one frame; an encoded data discrimination means that, by referring to the first and the second encoded image data, calculates variations of the representative value and the quantized value between the current-frame image and the image preceding by one frame, to generate, based on these variations, a control signal denoting a change in the pixel data of the current frame in each of the blocks; a one-frame-preceding-image calculation means that generates one-frame-preceding image data by choosing on a pixel to pixel basis, based on the control signal, either the current-frame image data or the second decoded image data; and an image data compensation means that compensates a gray-scale value of the current-frame image, based on the current-frame image data and the one-frame-preceding image data.

A second image processor according to the present invention that corrects and outputs image data representing a gray-scale value of each of pixels of an image, based on a change in the gray-scale value of the each pixel, the image processor includes an encoding means that encodes image data representing a current-frame image, to output the encoded image data corresponding to the current-frame image; a decoding means that decodes the encoded image data, to output first decoded image data corresponding to the current-frame image data; a delay means that delays the encoded image data for a period equivalent to one frame; a decoding means that decodes the encoded image data outputted from the delay means, to output second decoded image data corresponding to the image data preceding the current frame by one frame; a means that by calculating on a pixel to pixel basis a variation between the first and the second decoded image data and an error amount between the current-frame image data and the first decoded image data, generates one-frame-preceding image data by choosing on a pixel to pixel basis, based on the variation and the error amount, either the current-frame image data or the second decoded image data; and an image data compensation means that compensates a gray-scale value of the current-frame image, based on the current-frame image data and the one-frame-preceding image data.

According to the first image processor of the invention, by making reference to the first and the second encoded image data, variations of a representative value and a quantized value between a current-frame image and that preceding by one frame are calculated; a control signal that denotes a change in the current-frame pixel data in each of the blocks are generated based on these variations; based on the control signal, the one-frame-preceding image data is generated by choosing either the current-frame image data or the second decoded image data on a pixel to pixel basis. Therefore, an appropriate compensation voltage can be applied to the liquid crystal without being affected by an encoding and decoding error even in cases of image data being inputted that is added with a pseudo gray-scale signal.

According to the second image processor of the invention, a variation between the first and the second decoded image data, and an error amount between a current-frame image data and the first decoded image data are calculated on a pixel to pixel basis; the one-frame-preceding image data is generated by choosing on a pixel to pixel basis either the current-frame image data or the second decoded image data. Therefore, an appropriate compensation voltage can be applied to the liquid crystal without being affected by an encoding/decoding error even in cases of image data being inputted that are added with a pseudo gray-scale signal.

### BRIEF DESCRIPTION OF DRAWINGS

FIG. 1 is a block diagram illustrating an aspect of an image processor for driving a liquid crystal according to the present invention;

FIG. 2 is graphs illustrating response characteristics of a liquid crystal;

FIG. 3 is diagrams for explaining processes of generating one-frame-preceding image data;

FIG. 4 is diagrams for explaining processes of generating one-frame-preceding image data;

FIG. 5 is diagrams for explaining processes of generating one-frame-preceding image data;

FIG. 6 is a flow chart illustrating an operation of the image processor for driving a liquid crystal according to the invention;

FIG. 7 is graphs illustrating characteristics of variables k₁ and k₂;

FIG. 8 is graphs illustrating characteristics of variables kₐ, k_{b}, k_{c}, and k_{d};

FIG. 9 a block diagram illustrating an example of an internal configuration of an image data compensation unit;

FIG. 10 is a schematic diagram illustrating a configuration of a look-up table;

FIG. 11 is a histogram illustrating an example of response speed of the liquid crystal;

FIG. 12 is a histogram illustrating an example of compensation amounts stored in the look-up table;

FIG. 13 is a block diagram illustrating an example of another internal configuration of the image data compensation unit;

FIG. 14 is a histogram illustrating an example of compensated image data stored in the look-up table;

FIG. 15 is a block diagram illustrating another aspect of an image processing unit for driving a liquid crystal according to the invention;

FIG. 16 is diagrams for explaining processes of generating one-frame-preceding image data;

FIG. 17 is diagrams for explaining processes of generating one-frame-preceding image data;

FIG. 18 is diagrams for explaining processes of generating one-frame-preceding image data;

FIG. 19 is a flow chart illustrating another operation of the image processor for driving the liquid crystal according to the invention;

FIG. 20 is a block diagram illustrating still another aspect of an image processing unit for driving a liquid crystal according to the invention;

FIG. 21 is diagrams for explaining processes of generating one-frame-preceding image data D_{q0};

FIG. 22 is diagrams for explaining an encoding/decoding error;

FIG. 23 is diagrams for explaining processes of generating the one-frame-preceding image data D_{q0};

FIG. 24 is diagrams for explaining the encoding and decoding error;

FIG. 25 is a flow chart illustrating another operation of the image processor; and

FIG. 26 is graphs illustrating characteristics of variables k₁ and k₂.

### DETAILED DESCRIPTION

### Embodiment 1

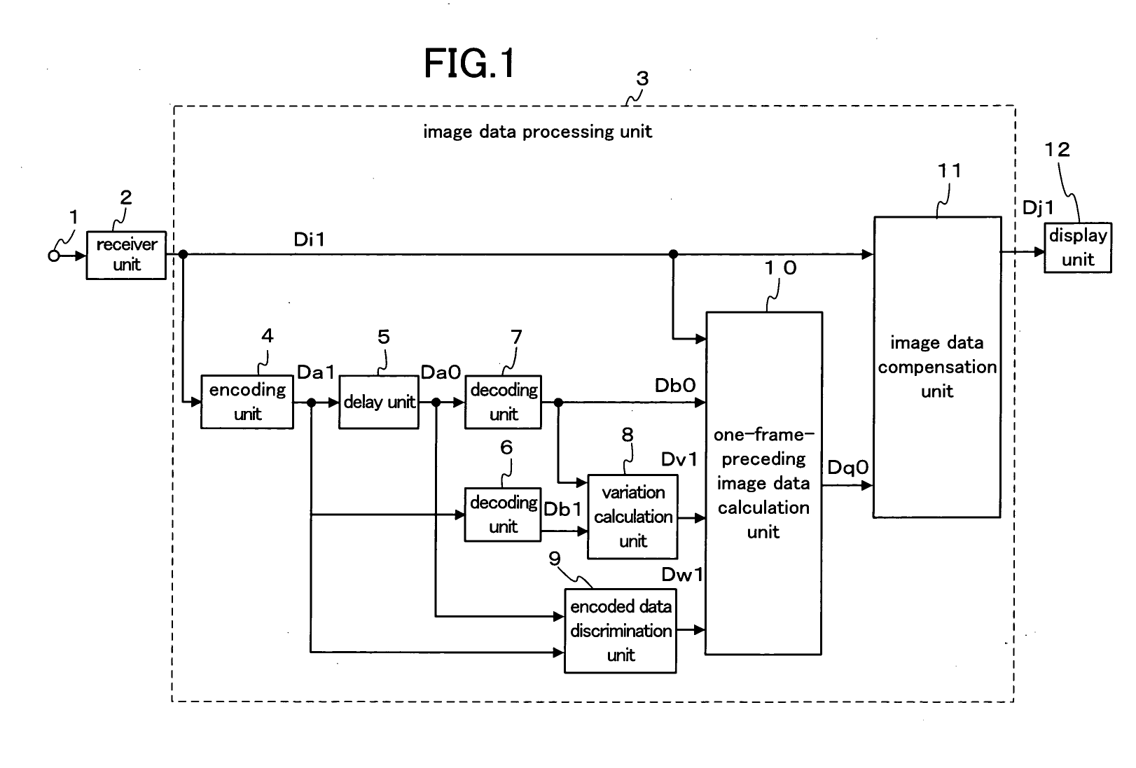

FIG. 1 is a block diagram illustrating a configuration of a liquid crystal display device provided with an image processor according to the present invention. A receiver unit 2 performs processes such as channel selection and demodulation of a video signal inputted through an input terminal 1, and successively outputs an image data Dᵢ₁ representing an image of one frame (a current-frame image) to an image data processing unit 3. The image data processing unit 3 is composed of an encoding unit 4, a delay unit 5, decoding units 6 and 7, a variation calculation unit 8, an encoded data discrimination unit 9, a one-frame-preceding-image calculation unit 10, and an image data compensation unit 11. The image data processing unit 3 corrects the image data Dᵢ₁ based on a change in the gray-scale value and output a compensated image data Dⱼ₁ to a display unit 12. The display unit 12 displays the image by applying to the liquid crystal predetermined driving voltages designated by the compensated image data Dⱼ₁.

An operation of the image data processing unit 3 will be explained bellow.

The encoding unit 4 encodes the image data Dᵢ₁ by using a block truncation coding (BTC) such as FBTC and GBTC, and output an encoded image data Dₐ₁. The encoded image data Dₐ₁ is generated by dividing the image data Dᵢ₁ into a plurality of blocks and quantizing image data in each of the blocks using quantizing thresholds, which is determined based on a representative value denoting magnitude of pixel data in each of the blocks. An averaged value Lₐ₁ and a dynamic range Dₐ₁ are used as the representative value. The encoded image data Dₐ₁ consists of the averaged value Lₐ₁, the dynamic range L_{b1} of the image data in each of the blocks and a quantized value Q of each of the pixel data.

The delay unit 5 delays the encoded image data Dₐ₁, for a period equivalent to one frame and output encoded image data Dₐ₀ corresponding to the image preceding by one frame. Memory size of the delay unit 5, which is necessary for delaying the encoded image data Dₐ₁, can be decreased by increasing an encoding rate (data compression rate) of the image data Dᵢ₁ in the encoding unit 4.

The decoding unit 6 decodes the encoded image data Dₐ₁ and output decoded image data D_{b1} corresponding to the image data Dᵢ₁. The decoding unit 7 decodes the encoded image data Dₐ₀ and output decoded image data D_{b0} corresponding to the image preceding by one frame.

The variation calculation unit 8 calculates difference between the decoded image data D_{b1} of the current frame and the decoded image data D_{b0} preceding by one frame on a pixel to pixel basis, and output absolute value of calculated difference in each pixel as variation Dᵥ₁. The variation Dᵥ₁ is inputted into the one-frame-preceding-image calculation unit 10 along with the image data Dᵢ₁ and the decoded image data D_{b0}.

The encoded data discrimination unit 9 receives the encoded image data Dₐ₁ and Dₐ₀ outputted from the encoding unit 4 and the delay unit 5, respectively. The encoded data discrimination unit 9 outputs a control signal D_{w1} that denotes a motion or a still image region in the current-frame image based on a change in the encoded image data Dₐ₁ from the encoded image data Dₐ₀ preceding by one frame on a pixel to pixel basis. The control signal D_{w1}=1 is outputted for a pixel and block of which gray-scale value has varied from previous frame, and the control signal D_{w1}=0 is outputted for a pixel of which gray-scale value remain same or almost same.

The control signal D_{w1} is determined by calculating |Lₐ₁−Lₐ₀|, a variation of the averaged values between current and previous frames in each block, and |L_{b1}−L_{b0}|, a variation of the dynamic ranges between current and previous frames in each block. In a case of these variations of each block exceeding predetermined thresholds (Tₕₐ, T_{hb}), the control signal D_{w1}=1 is outputted for all pixels in the block. When the control signal D_{w1}=1 is outputted for all pixels in the block, the one-frame-preceding-image calculation unit 10 discriminates between a motion image and a still image on a pixel to pixel basis according to the variation Dᵥ₁ of each pixel. If the variation Dᵥ₁ exceeds the predetermined threshold (Tₕᵥ), an associated pixel is regarded as representing a motion image. On the other hand, if the variation Dᵥ₁ is equal to or smaller than the threshold, an associated pixel is regarded as representing a still image.

At the same time, if the variations |Lₐ₁−Lₐ₀| and |L_{b1}−L_{b0}| are equal to or smaller than the respective thresholds, discrimination between a motion and a still images is made based on a variation |Q₁−Q₀| of quantized value Q₁ and Q₀ of each pixel. If |Q₁−Q₀| is 1 or 0, associated pixel is regarded as representing a still image, and the control signal D_{w1}=0 is outputted. If |Q₁−Q₀| exceeds 1, an associated pixel is regarded as representing a motion image, and the control signal D_{w1}=1 is outputted.

The control signal D_{w1} outputted from the encoded data discrimination unit 9 is inputted into the one-frame-preceding-image calculation unit 10.

The one-frame-preceding-image calculation unit 10 generates one-frame-preceding image data D_{q0} by selecting the image data Dᵢ₁ or the decoded image data D_{b0} preceding by one frame on a pixel to pixel basis, based on a value of the control signal D_{w1} and the variation Dᵥ₁. If the control signal D_{w1}=0, an associated pixel is regarded as representing a still image, and the image data Dᵢ₁ is selected for this pixel. If the control signal D_{w1}=1 and the variation Dᵥ₁ is large, an associated pixel is regarded as representing a still image, and the image data Dᵢ₁ is selected for this pixel. If the control signal D_{w1}=1 and the variation Dᵥ₁ is large, an associated pixel is regarded as representing a motion image, and the decoded image data D_{b0} is selected for this pixel. The one-frame-preceding image data D_{q0} generated by selecting the image data Dᵢ₁ or the decoded image data D_{b0} in a manner described above is inputted into the image data compensation unit 11.

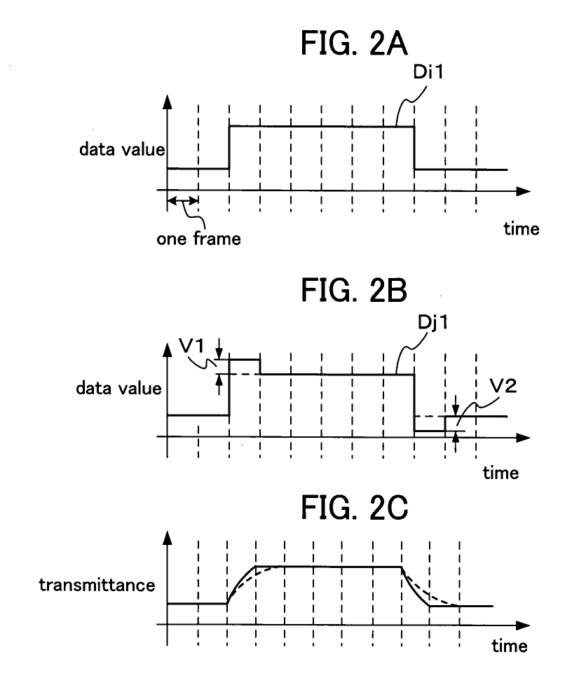

The image data compensation unit 11 compensates the image data Dᵢ₁ so that the liquid crystal reaches predetermined transmittances designated by the image data Dᵢ₁ within one frame period, based on inter-frame changes in gray-scale values obtained by comparing the image data Dᵢ₁ with the one-frame-preceding image data D_{q}, and output the compensated image data Dⱼ₁. FIG. 2 is graphs illustrating a response characteristic when a driving voltage based on the compensated image data Dⱼ₁ is applied to the liquid crystal. FIG. 2A is a graph illustrating the image data Dᵢ₁; FIG. 2B, a graph illustrating the compensated image data Dⱼ₁; and FIG. 2C is a graph illustrating a response characteristic of the liquid crystal obtained by applying a driving voltage based on the compensated image data Dⱼ₁. The broken line in FIG. 2C indicates a response characteristic of the liquid crystal when the driving voltage based on the image data Dᵢ₁ is applied. As shown in FIG. 2B, the compensated image data Dⱼ₁ is generated by adding compensation amount V₁ to image data Dᵢ₁, or subtracting V₂ from the image data Dᵢ₁. By applying the driving voltage based on the compensated image data Dⱼ₁, the liquid crystal can reach the predetermined transmittances designated by the image data Dᵢ₁ approximately within one frame period as shown in FIG. 2C.

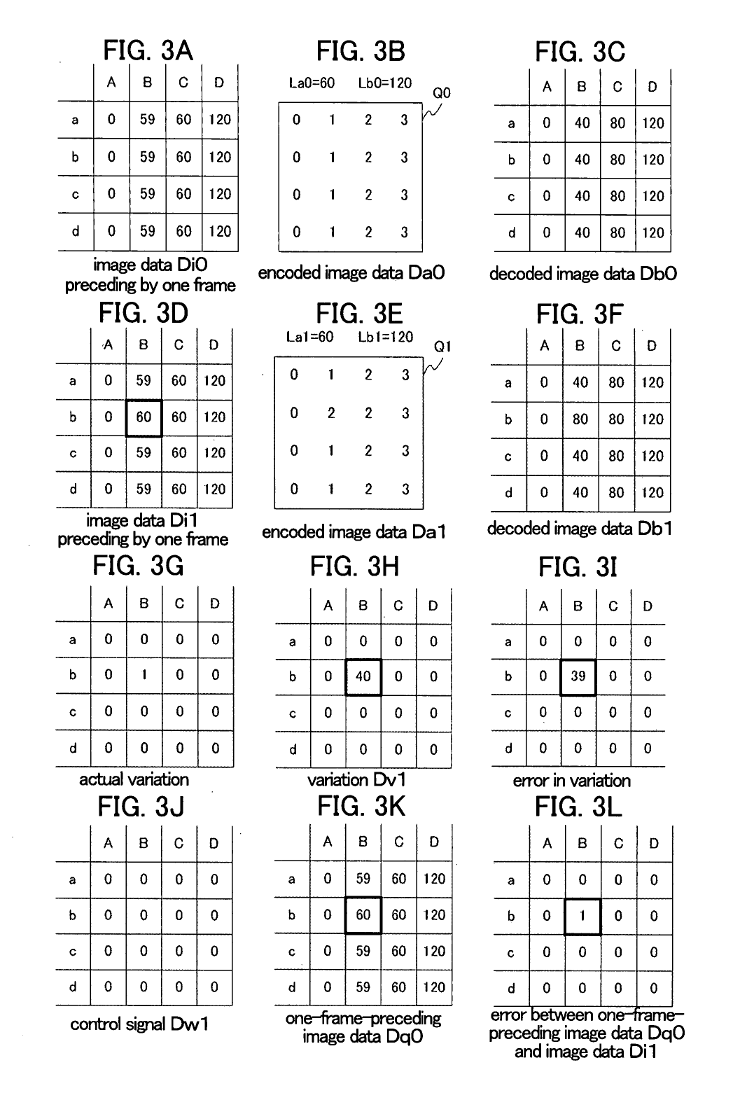

FIG. 3 through FIG. 5 are diagrams for explaining processes of generating the one-frame-preceding image data D_{q0} in the image data processing unit 3.

The processes of generating the one-frame-preceding image data D_{q0} will be explained bellow in detail with reference to FIG. 3 through FIG. 5. In the following explanation, Tₕₐ, T_{hb}, and Tₕᵥ represents a threshold for respective variations |Lₐ₁−Lₐ₀|, |L_{b1}−L_{b0}| and Dᵥ₁. These thresholds are Tₕₐ=10, T_{hb}=20, and Tₕᵥ=10, in the following explanation.

FIG. 3 are diagrams for explaining the processes of generating the one-frame-preceding image data D_{q0} in case that a still image added with pseudo gray-scale signals by a dither processing is inputted.

FIGS. 3D and 3A indicate values of the image data Dᵢ₁ of a current frame and image data D_{q0} preceding by one frame, respectively. As shown in FIG. 3D, a pixel data (b, B) in the image data Dᵢ₁ of the current frame varies from 59 to 60 after being added with a pseudo gray-scale signal by the dither processing.

FIGS. 3B and 3E indicate the encoded data Dₐ₀ and Dₐ₁ corresponding to the image data Dᵢ₀ and Dᵢ₁ shown in FIGS. 3A and 3D, respectively. As shown in FIGS. 3B and 3E, the averaged values and the dynamic ranges of the image data Dᵢ₀ and Dᵢ₁ shown in FIGS. 3A and 3D are Lₐ₀=Lₐ₁60 and L_{b0}=L_{b1}=120, respectively. The quantized values Q₀ and Q₁ are calculated by 2 bit quantization.

FIGS. 3C and 3F indicate the decoded image data D_{b0} and D_{b1} obtained by decoding the encoded image data Dₐ₀ and Dₐ₁ shown in FIGS. 3B and 3E, respectively.

FIG. 3G indicates a difference between the image data Dᵢ₀ and Dᵢ₁ shown in FIGS. 3A and 3D, an actual variation of the image. FIG. 3H indicates the variation Dᵥ₁, a difference between the decoded image data D_{b0} and D_{b1} shown in FIGS. 3C and 3F. The actual variation of the pixel data (b, B) is 1 as shown in FIG. 3G, however, the variation Dᵥ₁ of the same pixel is 40 as shown in FIG. 3H, due to an influence of error occurring in the encoding and decoding process.

FIG. 3I indicates an error between the actual variations shown in FIG. 3G and the variation Dᵥ₁ shown in FIG. 3H. From these diagrams, it is found that a large error occurs in the pixel data (b, B) where the pseudo gray-scale signal is added, due to the error in the encoding and decoding process.

FIG. 3J indicates the control signal D_{w1} generated based on the encoded image data Dₐ₀ and Dₐ₁ shown in FIGS. 3B and 3E. As shown in FIGS. 3B and 3E, an averaged value variation between the current frame and the frame preceding by one frame |Lₐ₁−Lₐ₀|=0, and a dynamic range variation |L_{b1}−L_{b0}|=0, and both variations are smaller than the respective thresholds Tₕₐ=10 and T_{hb}=20. A quantized value variation |Q₁−Q₀| is 1 in the pixel (B, b) and 0 in the other pixels. Accordingly, the encoded discrimination unit 9 outputs the control signal D_{w1}=0 for all pixels.

FIG. 3K indicates the one-frame-preceding image data D_{q0} generated by selecting the decoded image data D_{b0} shown in FIG. 3C or the image data Dᵢ₁ shown in FIG. 3D on a pixel to pixel basis, based on the variation Dᵥ₁ shown in FIG. 3H and the control signal D_{w1} shown in FIG. 3J. While the variation Dᵥ₁ of the pixel data (b, B) exceeds the threshold Tₕᵥ (=10) as shown in FIG. 3H, since the control signal D_{w1} is 0 for all pixels as shown in FIG. 3J, the one-frame-preceding-image calculation unit 10 generates the one-frame-preceding image data D_{q0} by selecting the image data Dᵢ₁ of the current frame for all pixels.

FIG. 3L indicates an error between the image data Dᵢ₀ preceding by one frame shown in FIG. 3A and the one-frame-preceding image data D_{q0} shown in FIG. 3K. As shown in FIG. 3L, by selecting the image data Dᵢ₁ of the current frame as the image data preceding by one frame based on the control signal D_{w1} and the variation Dᵥ₁, an encoding and decoding error due to the pseudo gray-scale signals can be corrected. In other words, changes in image data and the pseudo gray-scales are discriminated based on the averaged value variation |Lₐ₁−Lₐ₀|, the dynamic range variation |L_{b1}−L_{b0}|, and the quantized value variation |Q₁−Q₀| of each of the blocks, which are included in the encoded image data Dₐ₀ and Dₐ₁, and in case that the pseudo gray-scales is recognized, the image data Dᵢ₁ of the current frame is selected as the image data preceding by one frame. As a result, the encoding and decoding error due to the dither processing can be prevented.

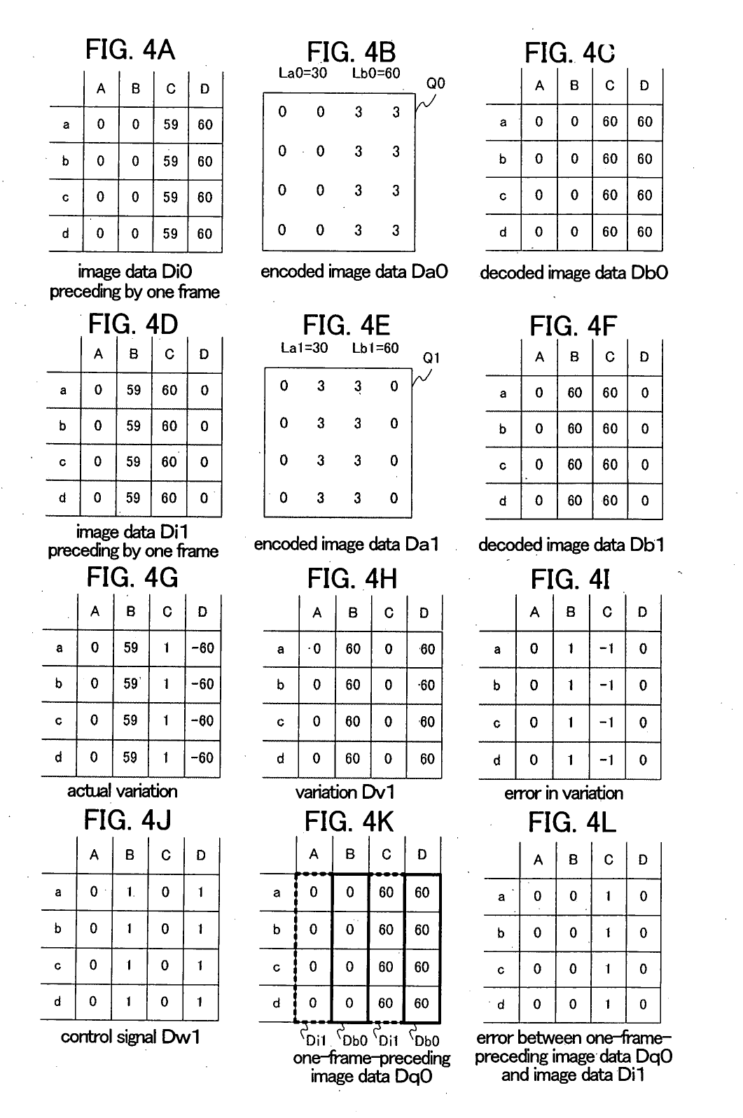

FIG. 4 are diagrams for explaining the operation of the image data processing unit 3 in case that a motion image is inputted.

FIGS. 4D and 4A indicate values of the image data Dᵢ₁ of a current frame and the image data Dᵢ₀ preceding by one frame, respectively. Comparing the image data Dᵢ₀ with the image data Dᵢ₁ shown in FIGS. 4A and 4D, pixel data in the B, C and D column vary from 0 to 59, 59 to 60, and 60 to 0, respectively.

FIGS. 4B and 4E indicate the encoded image data Dₐ₀, and Dₐ₁ corresponding to the image data Dᵢ₀ and Dᵢ₁ shown in FIGS. 4A and 4D, respectively. As shown in FIGS. 4B and 4E, the averaged values and the dynamic ranges of the image data Dᵢ₀ and Dᵢ₁ shown in FIGS. 4A and 4D are Lₐ₀=Lₐ₁=30 and L_{b0}=L_{b1}=60, respectively.

FIGS. 4C and 4F indicate the decoded image data D_{b0} and D_{b1} obtained by decoding the encoded image data Dₐ₀ and Dₐ₁ shown in FIGS. 4B and 4E, respectively.

FIG. 4G indicates differences between the image data Dᵢ₀ and Dᵢ₁ shown in FIGS. 4A and 4D, an actual variations of the image. FIG. 4H indicates the variation Dᵥ₁, a difference between the decoded image data D_{b0} and D_{b1} shown in FIGS. 4C and 4F.

FIG. 4I indicates an error between the actual variations shown in FIG. 4G and the variation Dᵥ₁ shown in FIG. 4H.

FIG. 4J indicates the control signal D_{w1} generated based on the encoded image data Dₐ₀, and Dₐ₁ shown in FIGS. 4B and 4E. As shown in FIGS. 4B and 4E, the averaged value variation between the current frame and the frame preceding by one frame |Lₐ₁−Lₐ₀|=0 and the dynamic range variation |L_{b1}−L_{b0}=0, and both variations are smaller than the respective thresholds Tₕₐ=10 and T_{hb}=20. A quantized value variation |Q₁−Q₀|=0 in pixels in the A and C columns and |Q₁−Q₀|=3 in pixels in the B and D columns. Accordingly, the encoded discrimination unit 9 outputs the control signal D_{w1}=0 for the pixels in the A and C columns and the control signal D_{w1}=1 for the pixels in the B and D columns.

FIG. 4K indicates the one-frame-preceding image data D_{q0} generated by selecting the decoded image data D_{b0} shown in FIG. 4C or the image data Dᵢ₁ shown in FIG. 4D on a pixel to pixel basis, based on the variation Dᵥ₁ shown in FIG. 4H and the control signal D_{w1} shown in FIG. 4J. As shown in FIG. 4H, the variation Dᵥ₁ in pixels in the B and D columns is 60, exceeding the threshold Tₕᵥ (=10). As shown in FIG. 4J, the control signal D_{w1} in pixels in the A and C columns is 0 and 1 in pixels in the B and D columns. Accordingly, the one-frame-preceding-image calculation unit 10 generates the one-frame-preceding image data D_{q0} by selecting the image data Dᵢ₁ of the current frame for the pixels in the A and C columns and selecting the decoded image data D_{b0} for the pixels in the B and D columns.

FIG. 4L indicates an error between the image data Dᵢ₀ preceding by one frame shown in FIG. 4A and the one-frame-preceding image data D_{q0} shown in FIG. 4K. As shown in FIG. 4L, by selecting the image data Dᵢ₁ of the current frame or the decoded image data D_{b0} on a pixel to pixel basis, based on the control signal D_{w1} and the variation Dᵥ₁, the one-frame-preceding image data D_{q0} can be correctly generated. Furthermore, the error shown in FIG. 4L are smaller than those shown in FIG. 4I. This means the error in the variations between the one-frame-preceding image data D_{q0} and the image data Dᵢ₀ are smaller than those in the variation Dᵥ₁ between the decoded image data D_{b0} and Dbl.

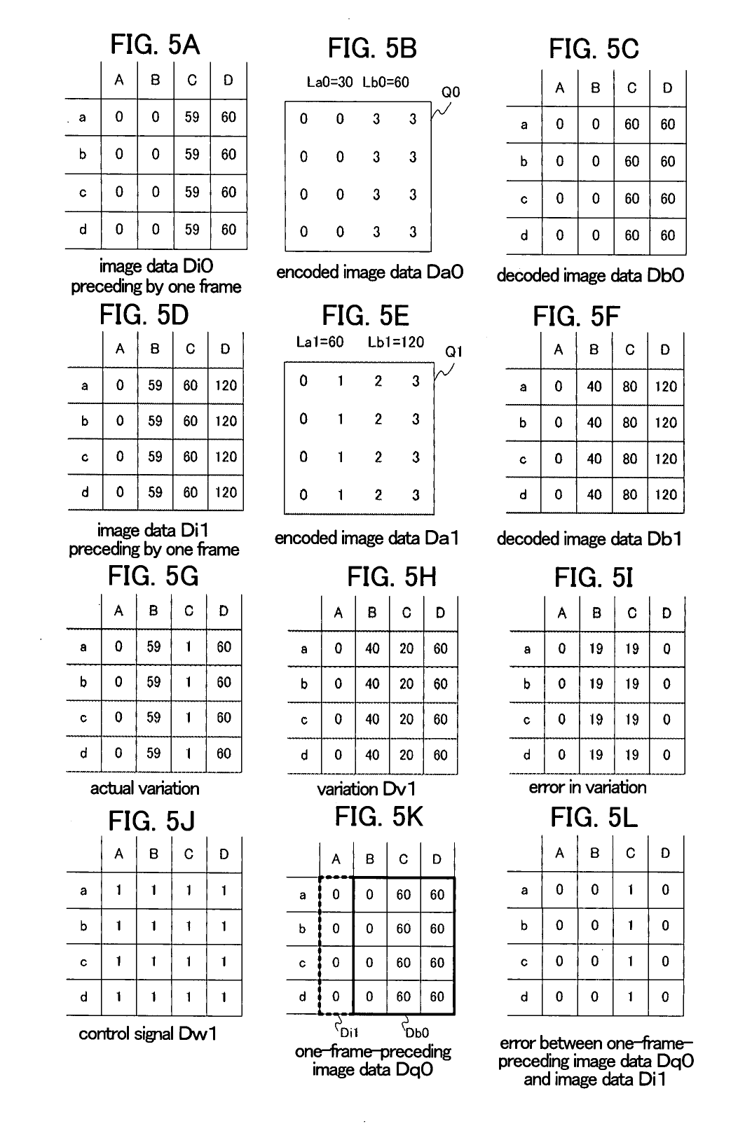

FIG. 5 are diagrams for explaining the operation of the image data processing unit 3 in case that another motion image being inputted.

FIGS. 5D and 5A indicate values of the image data Dᵢ₁ of a current frame and the image data Dᵢ₀ preceding by one frame, respectively. Comparing the image data Dᵢ₀ with the image data Dᵢ₁ shown in FIGS. 5A and 5D, pixel data in the B, C and D columns varies from 0 to 59, 59 to 60, and 60 to 120.

FIGS. 5B and 5E indicate the encoded image data Dₐ₀, and Dₐ₁ corresponding to the image data Dᵢ₀ and Dᵢ₁ shown in FIGS. 5A and 5D, respectively. As shown in FIGS. 5B and 5E, the averaged values and the dynamic ranges of the image data Dᵢ₀ and Dᵢ₁ shown in FIGS. 5A and 5D are Lₐ₀=30, Lₐ₁=60, L_{b0}=60 and L_{b1}=120, respectively.

FIGS. 5C and 5F indicate the decoded image data D_{b0} and D_{b1} obtained by decoding the encoded image data Dₐ₀ and Dₐ₁ shown in FIGS. 5B and 5E, respectively.

FIG. 5G indicates a difference between the image data Dᵢ₀ and Dᵢ₁ shown in FIGS. 5A and 5D, an actual variation of the image. FIG. 5H indicates the variation Dᵥ₁, a difference between the decoded image data D_{b0} and D_{b1} shown in FIGS. 5C and 5F.

FIG. 5I indicates an error between the actual variations shown in FIG. 5G and the variation Dᵥ₁ shown in FIG. 5H.

FIG. 5J indicates the control signal D_{w1} generated based on the encoded image data Dₐ₀, and Dₐ₁ shown in FIGS. 5B and 5E. As shown in FIGS. 5B and 5E, the averaged value variation between the current frame and the frame preceding by one frame |Lₐ₁−Lₐ₀|=30, and the dynamic range variation |L_{b1}−L_{b0}|=60, and both variations exceed the respective thresholds Tₕₐ=10 and T_{hb}=20. Thus, the control signal D_{w1}=1 is outputted for all pixels in the block.

FIG. 5K indicates the one-frame-preceding image data D_{q0} generated by selecting the decoded image data D_{b0} shown in FIG. 5C or the image data Dᵢ₁ shown in FIG. 5D on a pixel to pixel basis, based on the variation Dᵥ₁ shown in FIG. 5H and the control signal D_{w1} shown in FIG. 5J. As shown in FIG. 5H, the variation Dᵥ₁ of pixels in the B, C, and D columns are 40, 20, and 60, respectively, exceeding the threshold Tₕᵥ (=10). As shown in FIG. 5J, the control signal D_{w1} is 1 for all pixels. Accordingly, the one-frame-preceding-image calculation unit 10 generates the one-frame-preceding image data D_{q0} by selecting the image data Dᵢ₁ of the current frame for pixels in the A column and selecting the decoded image data D_{b0} for pixels in the B, C and D columns.

FIG. 5L indicates an error between the image data Dᵢ₀ preceding by one frame shown in FIG. 5A and the one-frame-preceding image data D_{q0} shown in FIG. 5K. As shown in FIG. 5L, by selecting the image data Dᵢ₁ of the current frame or the decoded image data D_{b0} based on the amount of the variation Dᵥ₁ when the averaged value variation |Lₐ₁−Lₐ₀| and the dynamic range variation |L_{b1}−L_{b0}−| of a block both exceed the respective predetermined thresholds (Tₕₐ, T_{hb}), the one-frame-preceding image data D_{q0} can be correctly generated with a small error.

As explained above with reference to FIG. 3 through FIG. 5, the averaged value variation |Lₐ₁−Lₐ₀|, the dynamic range variation |L_{b1}−L_{b0}|, and the quantized value variation |Q₁−Q₀| is calculated from the encoded image data Dₐ₀ and D_{b1}, and the control signal D_{w1} for determining whether each pixel represents a motion or a still image is generated based on these variations. Then the decoded image data D_{b0} or the image data Dᵢ₁ is selected on a pixel to pixel basis based on the control signal D_{w1} and the variation Dᵥ₁, and the one-frame-preceding image data D_{q0} is reproduced correctly. As a result, even in case that the image data Dᵢ₁ added with pseudo gray-scale signals are inputted, the appropriate compensation voltages are applied to the liquid crystal without affected by the encoding and decoding error.

To apply such encoding methods as JPEG, JPEG-LS, and JPEG2000, which converts image data into data in the frequency domain, in the encoding unit 4, a low frequency component is used as a representative value of a block. Those encoding methods for a still image are also applicable to an irreversible encoding whereby decoded image data is not in perfect agreement with the image data before encoded.

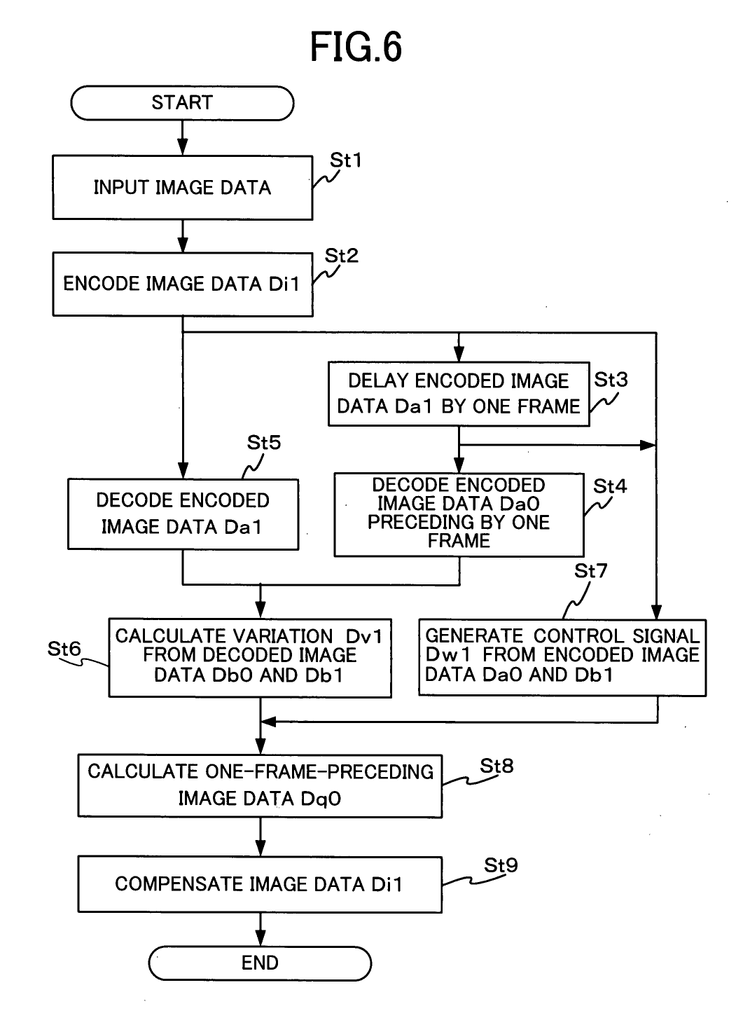

FIG. 6 is a block diagram illustrating the above-explained processing steps executed by the image data processing unit 3.

First, the image data Dᵢ₁ is inputted into the image data processing unit 3 (St1). The encoding unit 4 encodes the image data Dᵢ₁ inputted thereto, and output the encoded image data Dₐ₁ (St2). The delay unit 5 delays the encoded image data Dₐ₁ for one frame period, and output the encoded image data Dₐ₀ preceding by one frame (St3). The decoding unit 7 decodes the encoded image data Dₐ₀ preceding by one frame and outputs the decoded image data D_{b0} corresponding to the image data Dᵢ₀ preceding by one frame (St4). In parallel with these processes, the decoding unit 6 decodes the encoded image data Dₐ₁, and output the decoded image data D_{b1} corresponding to the image data Dᵢ₁ of a current frame (St5).

The variation calculation unit 8 calculates a difference between the decoded image data D_{b1} of the current frame and the decoded image data D_{b0} preceding by one frame on a pixel to pixel basis, and output absolute values of the difference as the variation Dᵥ₁ (St6). In parallel with this process, the encoded data discrimination unit 9 compares the image data Dᵢ₁ of the current frame with the encoded image data Dₐ₀ preceding by one frame, and in case that the variation |Lₐ₁−Lₐ₀| and |L_{b1}−L_{b0}| of a block exceed the respective predetermined thresholds (Tₕₐ, T_{hb}), the control signal D_{w1}=1 is outputted for all pixels in this block. On the other hand, in case that the variations |Lₐ₁−Lₐ₀| and |L_{b1}−L_{b0}| are equal to or smaller than the respective thresholds, the control signal D_{w1}=0 is outputted for a pixel of which quantized value variation |Q₁−Q₀| is 0 or 1, and the control signal D_{w1}=1 is outputted for a pixel of which variation |Q₁−Q₀| is larger than 1 (St7).

The one-frame-preceding-image calculation unit 10 selects the decoded image data D_{b0} for a pixel of which variations Dᵥ₁ is larger than the predetermined threshold (Tₕᵥ) and of which control signal D_{w1} is 1, and selects the image data Dᵢ₁ as image data preceding by one frame for a pixel of which variation Dᵥ₁ is smaller than the predetermined threshold and of which control signals D_{w1} is 0, and outputs the one-frame-preceding image data D_{q0} (St8).

The image data compensation unit 11 calculates compensation amounts necessary for driving the liquid crystal to reach predetermined transmittances designated by the image data Dᵢ₁ within one frame period based on changes in gray-scale values obtained by comparing the one-frame-preceding image data D_{q0} with the image data Dᵢ₁, and compensate the image data Dᵢ₁ using the compensation amounts, and outputs the compensated image data Dⱼ₁ (St9).

The processing steps St1 through St9 are executed for each pixel of the image data Dᵢ₁.

The one-frame-preceding image data D_{q0} may be calculated by the following Formula (1):

D_{q0}=min(k₁,k₂)×D_{b0}+(1−min(k₁,k₂))×Dᵢ₁ (1).

In above Formula (1), k₁ and k₂ are variables between 0 and 1, of which values vary depending on values of the variation Dᵥ₁ and the control signal D_{w1}. min(k₁, k₂) represents a smaller value of k₁ and k₂.

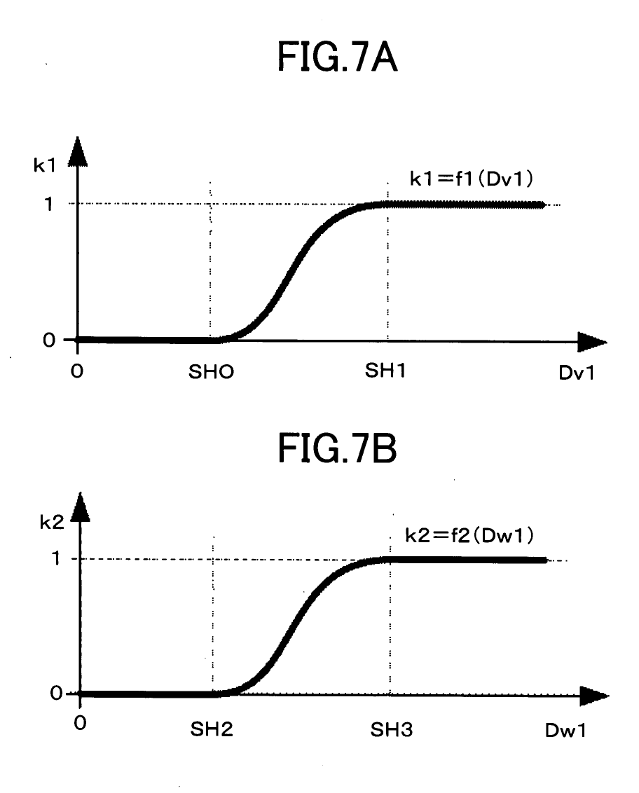

FIG. 7A and FIG. 7B are graphs illustrating relationships between the variation Dᵥ₁ and k₁, and the control signal D_{w1} and k₂, respectively. As shown in FIG. 7A, two thresholds SH₀ and SH₁ (SH₀<SH₁) are set for the variation Dᵥ₁; k₁=0 when Dᵥ₁<SH₀, 0≦k₁≦1 when SH₀≦Dᵥ₁≦SH₁, and k₁=1 when SH₁<Dᵥ₁. As shown in FIG. 7B, two thresholds SH₂ and SH₃ (SH₂<SH₃) are also set for the control signal D_{w1}; k₂=0 when D_{w1}<SH₂, 0≦k₂≦0 when SH₂≦D_{w1}≦SH₃, and k₂=1 when SH₃<D_{w1}.

As shown in Formula (1), when either one of k₁ and k₂ is 0, the image data Dᵢ₁ is selected as the one-frame-preceding image data D_{q0}, and when both k₁ and k₂ are 1, the decoded image data D_{b0} is outputted as the one-frame-preceding image data D_{q0}. In cases other than the above, weighted averages of the image data Dᵢ₁ and the decoded image data D_{b0} are calculated as the one-frame-preceding image data D_{q0} based on the smaller value of k₁ and k₂.

By using Formula (1), the one-frame-preceding image data D_{q0} can be calculated with smaller an error even when the variation Dᵥ₁ and the control signal D_{w1} are in the vicinity of respective thresholds.

The control signal D_{w1} may be calculated by the following Formula (2):

D_{w1}=k_{c}×(1−max(kₐ,k_{b}))+k_{d}×max(kₐ,k_{b}) (2).

In above Formula (2), kₐ and k_{b} are variables between 0 and 1, of which values vary depending on values of |Lₐ₁−Lₐ₀ and |L_{b1}−L_{b0}|, the variation of the averaged value and dynamic range. k_{c} is a variable between 0 and 1, of which value varies depending on a value of |Q₁−Q₀|, variation of the quantized value. k_{d} is a predetermined constant. max(kₐ, k_{b}) represents a larger value of kₐ and k_{b}.

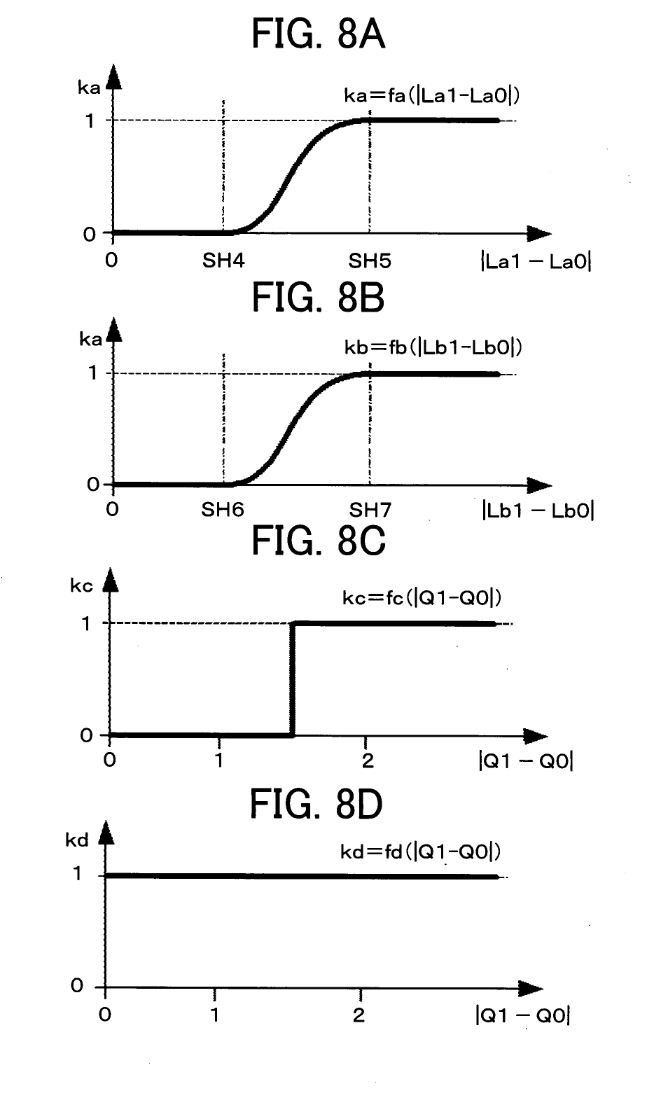

FIG. 8 are graphs illustrating each value of kₐ, k_{b}, k_{c}, and k_{d} in Formula (2).

FIG. 8A is a graph illustrating a relationship between |Lₐ₁−Lₐ₀| and kₐ. As shown in FIG. 8A, two thresholds SH₄ and SH₅ (SH₄<SH₅) are set for |Lₐ₁−Lₐ₀|; kₐ=0 when |Lₐ₁−Lₐ₀|<SH₄; 0≦k₂≦1 when SH₄≦|Lₐ₁−Lₐ₀|≦SH₅, and kₐ=1 when SH₅<|Lₐ₁−Lₐ₀|.

FIG. 8B is a graph illustrating a relationship between |L_{b1}−L_{b0}| and k_{b}. As shown in FIG. 8B, two thresholds SH₆ and SH₇ (SH₆<SH₇) are set for |L_{b1}−L_{b0}|; k_{b}=0 when |L_{b1}−L_{b0}|<SH₆, 0≦k_{b}≦1 when SH₆≦|L_{b1}−L_{b0}|≦SH₇, and k_{b}=0 when SH₇<|L_{b1}−L_{b0}|.

FIGS. 8C and 8D are graphs illustrating relationships between |Q₁−Q₀| and k_{c}, and |Q₁−Q₀| and k_{d}, respectively. The variable k_{c} shown in FIG. 8C is used when associated block is a still image or a slow motion image, where |Lₐ₁−Lₐ₀| is smaller than SH₅ and |L_{b1}−L_{b0}| are smaller than SH₇. On the other hand, the variable k_{d} (=1) shown in FIG. 8D is used when associated block is a motion image, where |Lₐ₁−Lₐ₀| is equal to or larger than SH₅ or |L_{b1}−L_{b0}| is equal to or larger than SH₇.

As shown in Formula (2), when both kₐ and k_{b} are 0, k_{c} with a characteristic shown in FIG. 8C is selected as the control signal D_{w1}, and when either one of kₐ and k_{b} is 1, k_{d} (=1) is selected as the control signal D_{w1}. In case other than the above, a weighted average of k_{c} and k_{d} is calculated as the control signal D_{w1} based on a larger value of kₐ and k_{b}.

### Embodiment 2

In Embodiment 1, the image data compensation unit 11 calculates compensation amounts based on changes in the gray-scale values obtained by comparing the one-frame-preceding image data D_{q0} with the image data Dᵢ₀, and generate the compensated image data Dⱼ₁. As another example, the image data compensation unit 11 may be configured to compensate the image data Dᵢ₁ by referring to compensation amounts stored in a look-up table, and output the compensated image data Dⱼ₁.

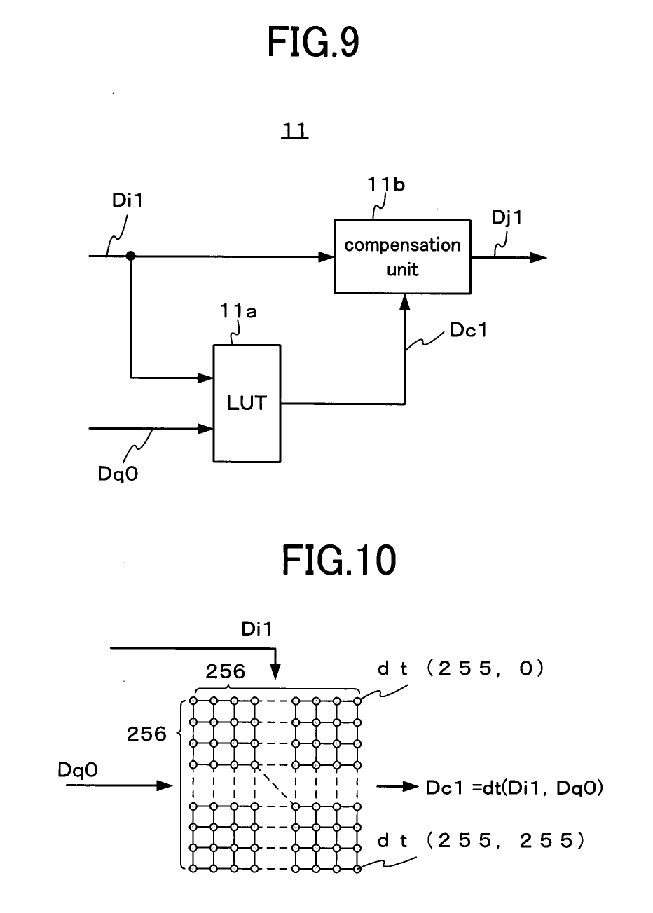

FIG. 9 is a block diagram illustrating an internal configuration of the image data compensation unit 11 according to Embodiment 2. A look-up table 11a receives the one-frame-preceding image data D_{q0} and the image data Dᵢ₁ and outputs compensation amount D_{c1} based on their values.

FIG. 10 is a schematic diagram illustrating an example of a configuration of the look-up table 11a. The image data Dᵢ₁ and the one-frame-preceding image data D_{q0} are inputted into the look-up table 11a as readout addresses. In case that the image data Dᵢ₁ and the one-frame-preceding image data D_{q0} are represented by 8 bit data, 256×256 patterns of data are stored in the look-up table 11a as the compensation amount D_{c1}. The compensation amount D_{c1} (=dt (Dᵢ₁, D_{q0})) corresponding to a value of the image data Dᵢ₁ and the one-frame-preceding image data D_{q0}. are read and outputted from the look-up table 11a. A compensation section 11b adds the compensation amount D_{c1} outputted from the look-up table 11a to the image data Dᵢ₁, and output the compensated image data Dⱼ₁.

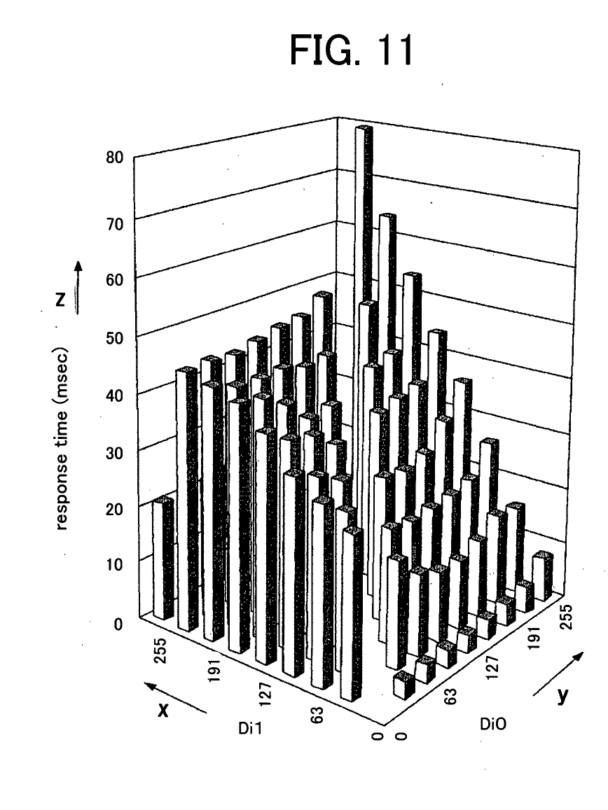

FIG. 11 is a diagram illustrating an example of response times of a liquid crystal. In FIG. 11, the x-axis denotes values of the image data Dᵢ₁ (gray-scale values of a current image), y-axis denotes values of the image data Dᵢ₀ preceding by one frame (gray-scale values of the image preceding by one frame), and z-axis denotes the response times required for the liquid crystal to reach transmittance corresponding to a gray-scale value of the image data Dᵢ₁ from transmittance corresponding to a gray-scale values of the preceding image data Dᵢ₀. In case that a gray-scale value of a current image is represented by 8 bit data, there are 256×256 patterns of the gray-scale value combinations of image data Dᵢ₀ and Dᵢ₁. Accordingly, there are 256×256 patterns of response times. The response time corresponding to the gray-scale-value combination are simplified into 8×8 cases in FIG. 11.

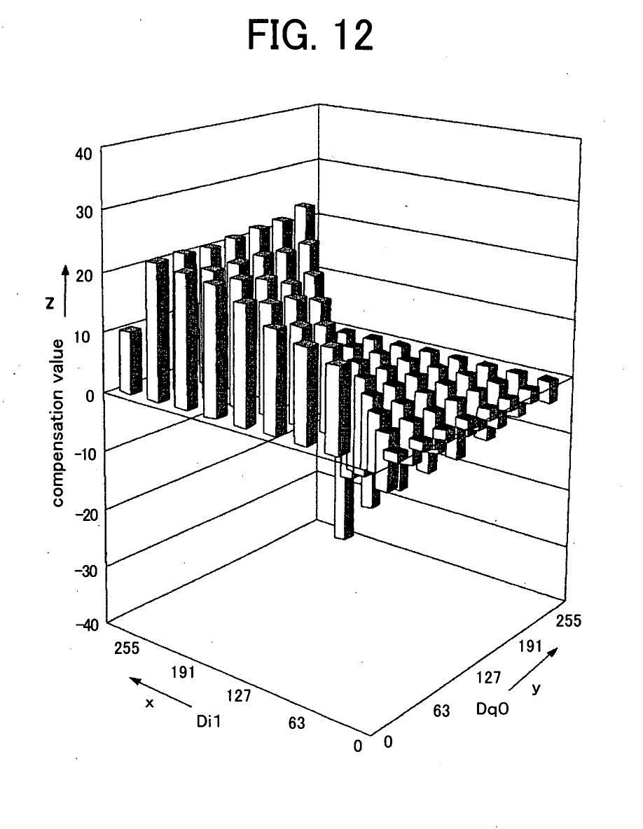

FIG. 12 is a diagram illustrating values of the compensation amount Dₐ₁ added to the image data Dᵢ₁ for the liquid crystal to have transmittances designated by the image data Dᵢ₁ within one frame period. When gray-scale values of image data are represented by 8 bit data, there are 256×256 patterns of the compensation amounts D_{c1} in accordance with a gray-scale value combinations of image data Dᵢ₀ and Dᵢ₁. The compensation amounts corresponding to the gray-scale value combination are indicated in FIG. 12 simplified into 8×8 patterns.

Since the response times of the liquid crystal varies depending on gray-scale value differences between image data Dᵢ₀ and Dᵢ₁ as shown in FIG. 11, 256×256 patterns of the compensation amounts D_{c1}, which correspond to the gray-scale values of both the image data Dᵢ₀ and Dᵢ₁, are stored in the look-up table 11a. Liquid crystals have a slow response speed, in particular, varying from halftone (gray) to high-tone (white). (There are also cases of a slow response in a reverse or another variations depending on type of liquid crystal panel or on an operation mode.) Accordingly, by setting large values of the compensation amounts Dᵢ₁=dt (Dᵢ₁, D_{q0}) corresponding to the one-frame-preceding image data D_{q0} representing halftone and the image data Dᵢ₁ representing high-tone, the response speed can be effectively improved. Moreover, since response characteristics of liquid crystal varies depending on its material, shape of the electrode, and temperature, the response time can be controlled depending on the characteristics of the liquid crystal by using the look-up table 11a provided with the compensation amount D_{c1} corresponding to such conditions.

As described above, by using the look-up table 11a storing the predetermined compensation amount D_{c1}, calculation required to output the compensated image data Dⱼ₁ can be reduced.

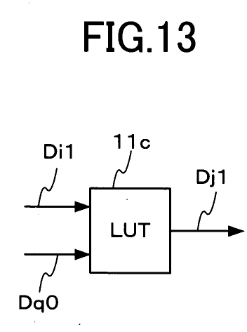

FIG. 13 is a block diagram illustrating another internal configuration of the image data compensation unit 11 according to Embodiment 2. A look-up table 11c shown in FIG. 13 receives the one-frame-preceding image data D_{q0} and the image data Dᵢ₁, and outputs the compensated image data Dⱼ₁ (=(Dᵢ₁, D_{q0})) based on values of both image data. The look-up table 11c stores the compensated image data Dⱼ₁ (=(Dᵢ₁, D_{q0})) obtained by adding to the image data Dᵢ₁ the compensation amounts D_{c1} (=dt (Dᵢ₁, D_{q0})) of 256×256 shown in FIG. 12. The compensated image data Dⱼ₁ is set not to exceed the gray-scale range in which the display unit 12 can display.

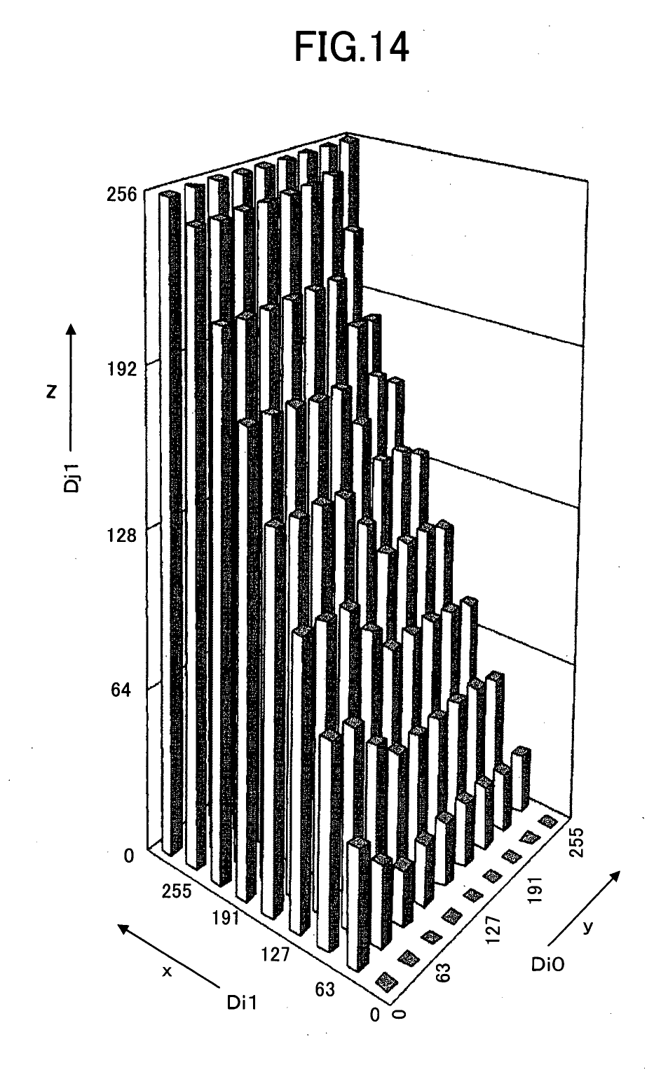

FIG. 14 is a diagram illustrating an example of the compensated image data Dⱼ₁ stored in the look-up table 11c. In case that gray-scale values of image data are represented by 8 bit data, there are 256×256 patterns of the compensation amount D_{c1} in accordance with a gray-scale value combinations of image data Dᵢ₀ and Dᵢ₁. The compensation amounts corresponding to the gray-scale-value combination are indicated in FIG. 14, simplified into 8×8 patterns.

By storing the compensated image data Dⱼ₁ in the look-up table 11c and outputting the compensated image data Dⱼ₁ based on the image data D_{q0} and Dᵢ₁, the calculation required to output the compensation amounts D_{c1} can be further reduced.

### Embodiment 3

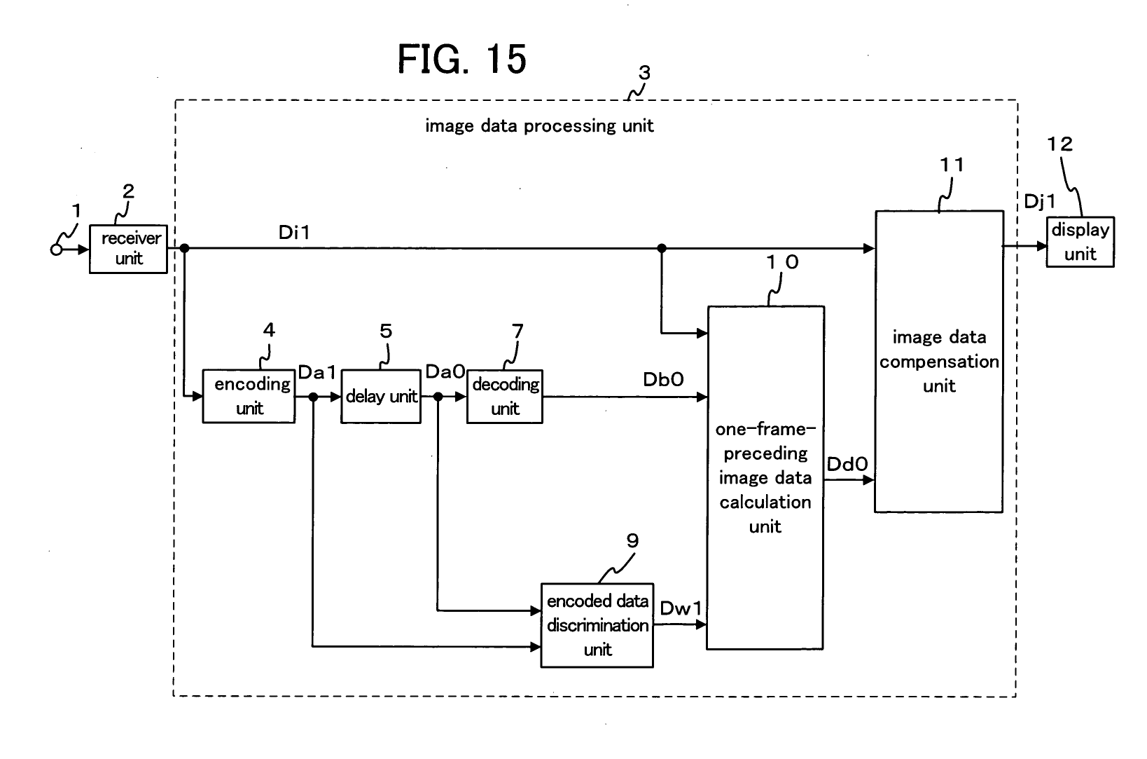

FIG. 15 is a block diagram illustrating another configuration of the liquid crystal display device provided with the image processor according to the present invention. The image data processing unit 3 in the image processor according to Embodiment 3 is composed of the encoding unit 4, the delay unit 5, the decoding unit 7, the encoded data discrimination unit 9, the one-frame-preceding-image calculation unit 10, and the image data compensation unit 11. The same numeral references are assigned to components equivalent to those in the image data processing unit 3 shown in FIG. 1.

In the image data processing unit 3 according to Embodiment 3, the one-frame-preceding-image calculation unit 10 generates the one-frame-preceding image data D_{q0} by selecting the image data Dᵢ₁ and the decoded image data D_{b0} on a pixel to pixel basis based on only the control signal D_{w1} outputted from the encoded data discrimination unit 9. If the control signal D_{w1}=1, the image data Dᵢ₀ is regarded as image data preceding by one frame and selected for an associated pixel. If the control signal D_{w1}=0, the image data Dᵢ₁ is regarded as image data preceding by one frame and selected for an associated pixel. A method of generating the control signal D_{w1} is the same as that in Embodiment 1.

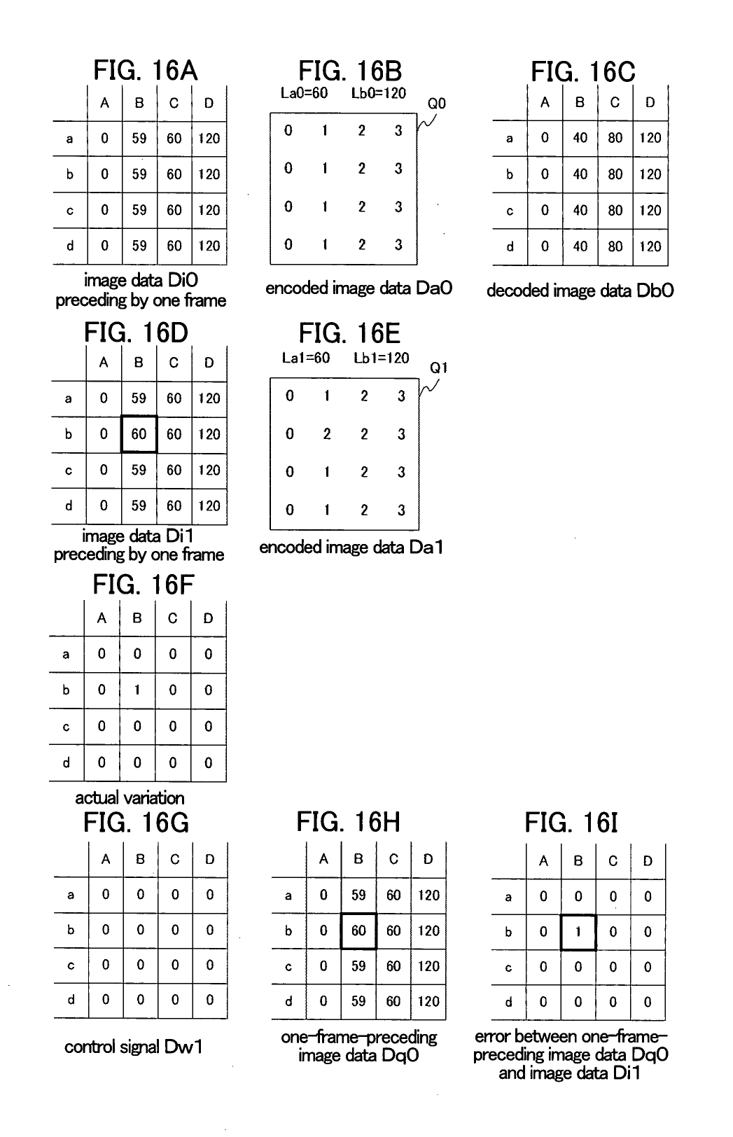

FIG. 16 through FIG. 18 are diagrams for explaining processes of generating the one-frame-preceding image data D_{q0} in the image data processing unit 3 according to Embodiment 3.

The processes of generating the one-frame-preceding image data D_{q0} will be explained in detail bellow with reference to FIG. 16 through FIG. 18. In the following explanations, Tₕₐ, and T_{hb} represents a threshold for respective variations |Lₐ₁−Lₐ₀|, |L_{b1}−L_{b0}|. These thresholds are Tₕₐ=10 and T_{hb}=20, in the following explanation.

FIG. 16 are diagrams for explaining the processes of generating the one-frame-preceding image data D_{q0} in case that a still image added with pseudo gray-scale signals by a dither processing is inputted.

FIGS. 16D and 16A indicate values of the image data Dᵢ₁ of a current frame and the image data Dᵢ₀ preceding by one frame, respectively. As shown in FIG. 16D, a pixel data (b, B) in the image data Dᵢ₁ of the current frame varies from 59 to 60 after being added with a pseudo gray-scale signal by the dither processing.

FIGS. 16B and 16E indicate the encoded data Dₐ₀ and Dₐ₁ corresponding to the image data Dᵢ₀ and Dᵢ₁ shown in FIGS. 16A and 16D, respectively. As shown in FIGS. 16B and 16E, the averaged values Lₐ₀ and Lₐ₁ and the dynamic ranges L_{b0} and L_{b1} of the image data Dᵢ₀ and Dᵢ₁ shown in FIGS. 16A and 16D are Lₐ₀=Lₐ₁=60 and L_{b0}=L_{b1}=120, respectively.

FIG. 16C indicates the decoded image data D_{b0} obtained by decoding the encoded image data Dₐ₀ shown in FIG. 16B.

FIG. 16F indicates a difference between the image data Dᵢ₀ and Dᵢ₁ shown in FIGS. 16A and 16D, an actual variation of the image.

FIG. 16G indicates the control signal D_{w1} generated based on the encoded image data Dₐ₀ and Dₐ₁ shown in FIGS. 16B and 16E. As shown in FIGS. 16B and 16E, the averaged value variation between the current frame and the frame preceding by one frame |Lₐ₁−Lₐ₀|=0 and the dynamic range variation |L_{b1}−L_{b0}|=0, and both variations are smaller than the respective thresholds Tₕₐ=10 and T_{hb}=20. The quantized value variation |Q₁−Q₀| in the pixel (b, B) is 1 and |Q₁−Q₀| in the other pixels are 0. Accordingly, the encoded discrimination unit 9 outputs the control signal D_{w1}=0 for all pixels.

FIG. 16H indicates the one-frame-preceding image data D_{q0} generated by selecting the decoded image data Dₕ₀ shown in FIG. 16C or the image data Dᵢ₁ shown in FIG. 16D on a pixel to pixel basis, based on the control signal D_{w1} shown in FIG. 16G. The control signal D_{w1}=0 for all pixels as shown in FIG. 16G. Accordingly, the one-frame-preceding-image calculation unit 10 generates the one-frame-preceding image data D_{q0} by selecting the image data Dᵢ₁ of the current frame for all pixels.

FIG. 16I indicates an error between the image data Dᵢ₀ preceding by one frame shown in FIG. 16A and the one-frame-preceding image data D_{q0} shown in FIG. 16H. As shown in FIG. 16I, the encoding and decoding error due to the pseudo gray-scale signals can be corrected, even in case of generating the one-frame-preceding image data D_{q0} based on the control signal D_{w1} only.

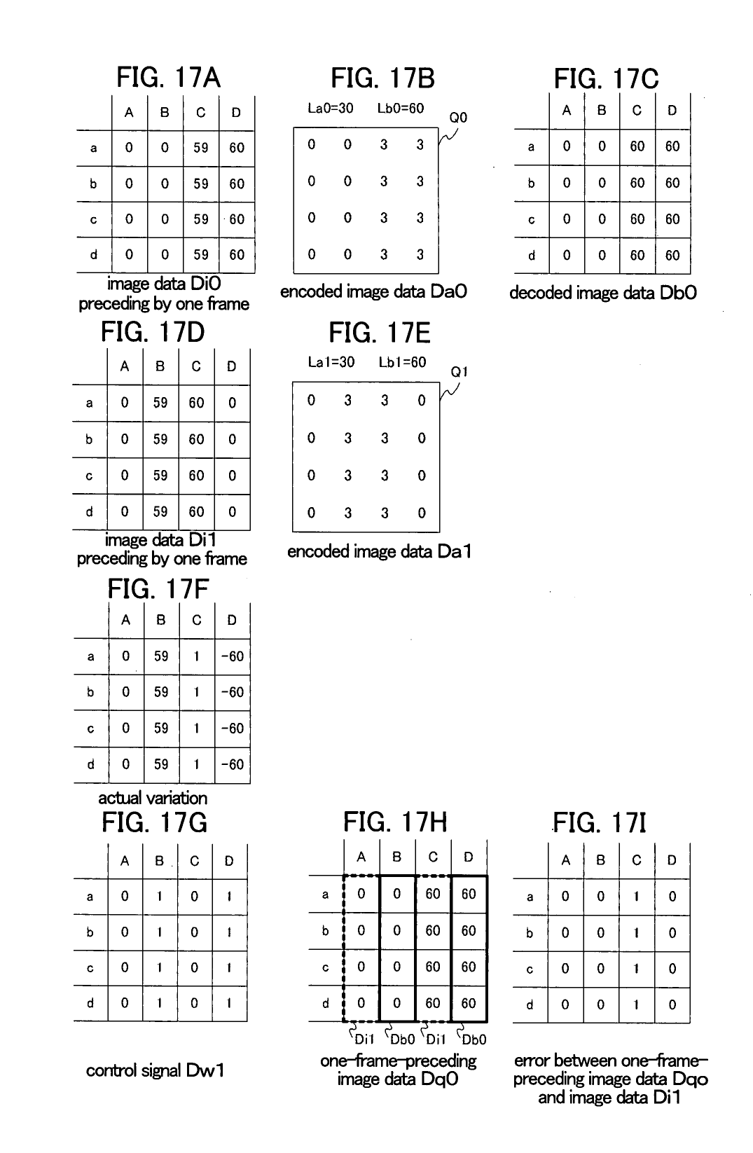

FIG. 17 are diagrams for explaining the operation of the image data processing unit 3 in a case of a motion image being inputted.

FIGS. 17A and 17D indicate values of the image data Dᵢ₁ of a current frame and the image data Dᵢ₀ preceding by one frame, respectively. Comparing the image data Dᵢ₀ with the image data Dᵢ₁ shown in FIGS. 17A and 17D, pixel data in the B, C and D column vary from 0 to 59, 59 to 60, and 60 to 0, respectively.

FIGS. 17B and 17E indicate the encoded image data Dₐ₀, and Dₐ₁ corresponding to the image data Dᵢ₀ and Dᵢ₁ shown in FIGS. 17A and 17D, respectively. As shown in FIGS. 17B and 17E, the averaged value and the dynamic range of the image data Dᵢ₀ and Dᵢ₁ shown in FIGS. 17A and 17D are Lₐ₀=30, Lₐ₁=30, L_{b0}=60 and L_{b1}=60, respectively.

FIG. 17C indicates the decoded image data D_{b0} obtained by decoding the encoded image data Dₐ₀ shown in FIG. 17B.

FIG. 17F indicates a difference between the image data Dᵢ₀ and Dᵢ₁ shown in FIGS. 17A and 17D, an actual variation of the image.

FIG. 17G indicates the control signal D_{w1} that is outputted based on the encoded image data Dₐ₀, and Dₐ₁ shown in FIGS. 17B and 17E. As shown in FIGS. 17B and 17E, the averaged value variation between the current frame and the frame preceding by one frame |Lₐ₁−Lₐ₀|=0 and the dynamic range variation |L_{b1}−L_{b0}|=0, and both variations are smaller than the respective thresholds Tₕₐ=10 and T_{hb}=20. A quantized value variation |Q₁−Q₀| n pixels in the A and C columns is 0 and |Q₁−Q₀| in pixels in the pixels in the B and D columns is 3. Accordingly, the encoded discrimination unit 9 outputs the control signal D_{w1}=0 for the pixels in the A and C columns and the control signal D_{w1}=1 for the pixels in the B and C columns.

FIG. 17H indicates the one-frame-preceding image data D_{q0} generated by selecting the decoded image data D_{b0} shown in FIG. 17C or the image data Dᵢ₁ shown in FIG. 17D on a pixel to pixel basis either, based on the control signal D_{w1} shown in FIG. 17G. As shown in FIG. 17G, the control signal D_{w1} is 0 for pixels in the A and C columns and 1 for the pixels in the B and D columns. Accordingly, the one-frame-preceding-image calculation unit 10 generates the one-frame-preceding image data D_{q0} by selecting the image data Dᵢ₁ of the current frame for the pixels in the A and C columns and selecting the decoded image data D_{b0} for the pixels in the B and D columns.

FIG. 17I indicates an error between the image data Dᵢ₀ preceding by one frame shown in FIG. 17A and the one-frame-preceding image data D_{q0} shown in FIG. 17H. As shown in FIG. 17I, by selecting the image data Dᵢ₁ of the current frame and the decoded image data D_{b0}, on a pixel to pixel basis, based on the control signal D_{w1}, the one-frame-preceding image data D_{q0} can be correctly generated.

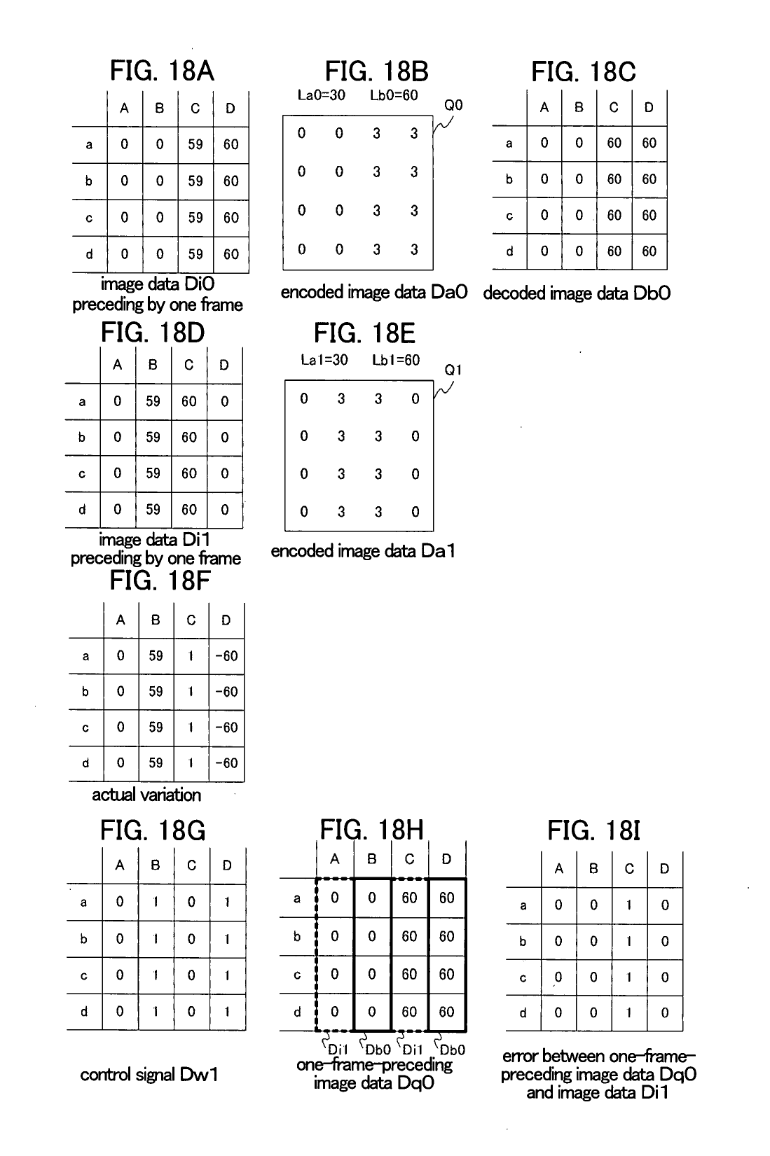

FIG. 18 are diagrams for explaining the operation of the image data processing unit 3 in case that another motion image being inputted.

FIGS. 18D and 18A indicate values of the image data D11 of a current frame and the image data Dᵢ₀ preceding by one frame, respectively. Comparing the image data Dᵢ₀ with the image data D11 shown in FIGS. 18A and 18D, pixel data in the B, C and D columns vary from 0 to 59, 59 to 60 and 60 to 120, respectively.

FIGS. 18B and 18E indicate the encoded image data Dₐ₀, and Dₐ₁ corresponding to the image data Dᵢ₀ and Dᵢ₁ shown in FIGS. 18A and 17D, respectively. As shown in. FIGS. 18B and 18E, the averaged values and dynamic ranges of the image data Dᵢ₀ and Dᵢ₁ shown in FIGS. 18A and 18D are Lₐ₀=30, Lₐ₁=60, L_{b0}=60 and L_{b1}=120, respectively.

FIG. 18C indicates the decoded image data D_{b0} obtained by decoding the encoded image data Dₐ₀ shown in FIG. 18B.

FIG. 18F indicates a differences between the image data Dᵢ₀ and Dᵢ₁ shown in FIGS. 18A and 18D, actual variations of the image.

FIG. 18G indicates the control signal D_{w1} that is outputted based on the encoded image data Dₐ₀ and Dₐ₁ shown in FIGS. 18B and 18E. As shown in FIGS. 18B and 18E, the averaged value variation between the current frame and the frame preceding by one frame |Lₐ₁−Lₐ₀|=30 and the dynamic range variation |L_{b1}−L_{b0}|=60, respectively, both exceeding the respective threshold Tₕₐ=10 and T_{hb}=20. Accordingly, the control signal D_{w1}=1 is outputted for all pixels in the block.

FIG. 18H indicates the one-frame-preceding image data D_{q0} generated by selecting the decoded image data D_{b0} shown in FIG. 18C or the image data D11 shown in FIG. 18D on a pixel to pixel basis, based on the control signal D_{w1} shown in FIG. 18G. Since the control signal D_{w1}=1 for all pixels as shown in FIG. 18G, the one-frame-preceding-image calculation unit 10 generates the one-frame-preceding image data D_{q0} by selecting the decoded image data D_{b0} for all pixels.

FIG. 18I indicates an error between the image data Dᵢ₀ preceding by one frame shown in FIG. 18A and the one-frame-preceding image data D_{q0} shown in FIG. 18H. As shown in FIG. 18I, by selecting the decoded image data D_{b0} as image data preceding by one frame, when the averaged value variation |Lₐ₁−Lₐ₀| and the dynamic range variation |L_{b1}−L_{b0}| of the block both exceed the respective predetermined thresholds (Tₕₐ, T_{hb}), the one-frame-preceding image data D_{q0} can be correctly generated with a small error.

As explained above with reference to FIG. 16 through FIG. 18, by selecting the one-frame-preceding image data D_{b0} or the image data D11 on a pixel to pixel basis, base on only the control signal D_{w1}, the one-frame-preceding image data D_{q0} can also be correctly generated without an influence of the encoding and decoding error.

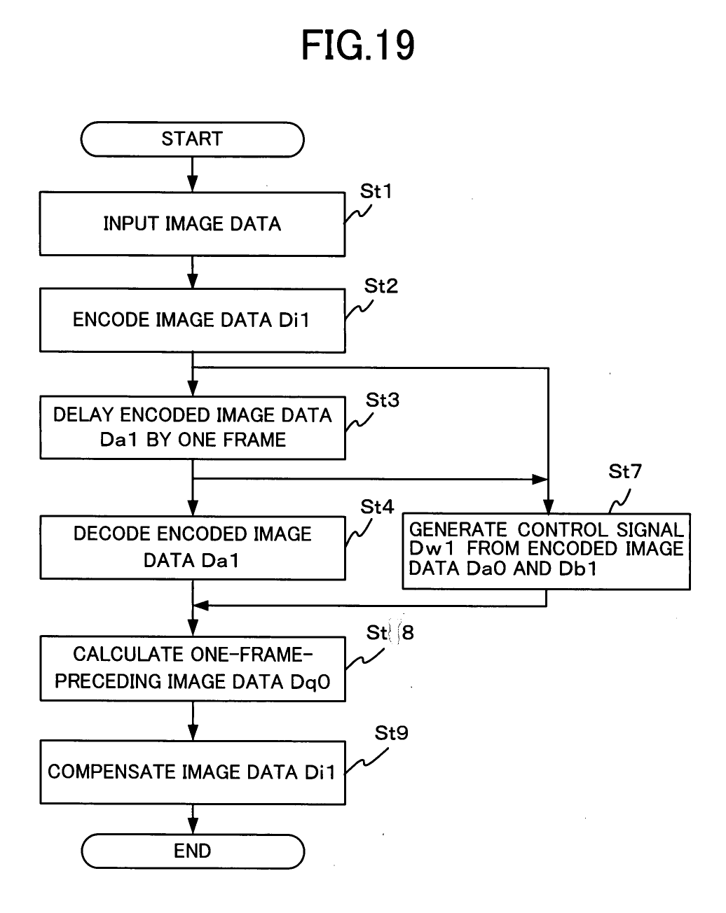

FIG. 19 is a flow chart illustrating the above-explained processing steps executed by the image processing unit for driving the liquid crystal according to Embodiment 3.

First, the image data Dᵢ₁ is inputted into the image data processing unit 3 (St1). The encoding unit 4 encodes the image data Dᵢ₁ inputted thereto, and outputs the encoded image data Dₐ₁ (St2). The delay unit 5 delays the encoded image data Dₐ₁ for one frame period, and output the encoded image data Dₐ₀ preceding by one frame (St3). The decoding unit 7 decodes the encoded image data Dₐ₀ and outputs the decoded image data D_{b0} corresponding to the image data Dᵢ₀ preceding by one frame (St4). In parallel with this process, the encoded data discrimination unit 9 compares the encoded image data Dₐ₀ preceding by one frame with the image data Dᵢ₁ of the current frame, and in case that the variation |Lₐ₁−Lₐ₀| and |L_{b1}−L_{b0}| of the block both exceed the respective predetermined thresholds (Tₕₐ, T_{hb}), the control signal D_{w1}=1 is outputted for all pixels in the block. On the other hand, in case that the variations |Lₐ₁−Lₐ₀| and |L_{b1}−L_{b0}| are equal to or smaller than the respective thresholds, the control signal D_{w1}=0 is outputted for pixel of which quantized value variation |Q₁−Q₀| is 0 or 1, and the control signal D_{w1}=1 is outputted for a pixel of which variation |Q₁−Q₀| is larger than 1 (St7).

The one-frame-preceding-image calculation unit 10 selects the decoded image data D_{b0} as image data preceding by one frame for a pixel of which control signal D_{w1}=1 and selects the image data Dᵢ₁ as image data preceding by one frame for a pixel of which control signal D_{w1}=0, and outputs the one-frame-preceding image data D_{q0} (St18).

The image data compensation unit 11 calculates compensation amounts necessary for driving the liquid crystal to reach predetermined transmittances designated by the image data Dᵢ₁ within one frame period based on changes in the gray-scale values obtained by comparing the one-frame-preceding image data D_{q0} with the image data Dᵢ₁, and compensates the image data Dᵢ₁ using the compensation amounts, and output the compensated image data Dⱼ₁ (St9).

The processing steps St1 through St9 are executed for each pixel of the image data D11.

### Embodiment 4

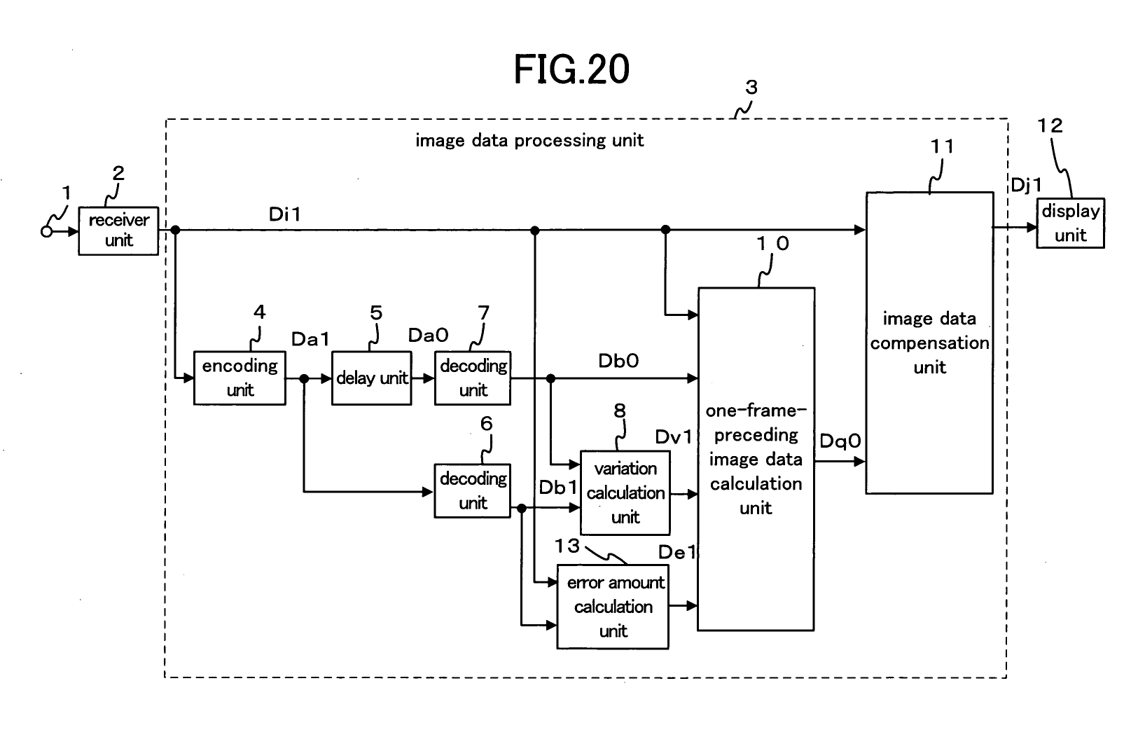

FIG. 20 is a block diagram illustrating another configuration of a liquid crystal display device provided with an image processor according to the present invention. The image data processing unit 3 according to Embodiment 4 is composed of the encoding unit 4, the delay unit 5, the decoding units 6 and 7, the variation calculation unit 8, an error amount calculation unit 13, the one-frame-preceding-image calculation unit 10, and the image data compensation unit 11. The same numeral references are assigned to components equivalent to those in the image data processing unit 3 shown in FIG. 1. Operation of each unit other than the error amount calculation unit 13 is same as that described in Embodiment 1.

The error amount calculation unit 13 calculates differences between the decoded image data D_{b1} corresponding to current-frame image data and the image data Dᵢ₁ on a pixel to pixel basis, and output absolute values of the differences as error amounts Dₑ₁. The error amounts Dₑ₁ are inputted into the one-frame-preceding-image calculation unit 10.

The one-frame-preceding-image calculation unit 10 generates the one-frame-preceding image data D_{q0} by selecting the image data Dᵢ₁ as image data preceding by one frame for a pixel of which variation Dᵥ₁ is smaller than the predetermined threshold SH₀ and for a pixel of which variation Dᵥ₁ is larger than the threshold SH₀ and equal to two times of the error amounts Dₑ₁, and selecting the decoded image data D_{b0} as image data preceding by one frame for a pixel of which variation Dᵥ₁ is larger than the threshold value SH₀ and of which variation Dᵥ₁ is not equal to two times of the error amounts Dₑ₁. The one-frame-preceding image data D_{q0} is inputted into the image data compensation unit 11.

The image data compensation unit 11 compensates the image data Dᵢ₁ so that the liquid crystals reach predetermined transmittances designated by the image data Dᵢ₁ within one frame period, based on changes in the gray-scale values obtained by comparing the image data Dᵢ₁ with the one-frame-preceding image data D_{q}, and outputs the compensated image data Dⱼ₁.

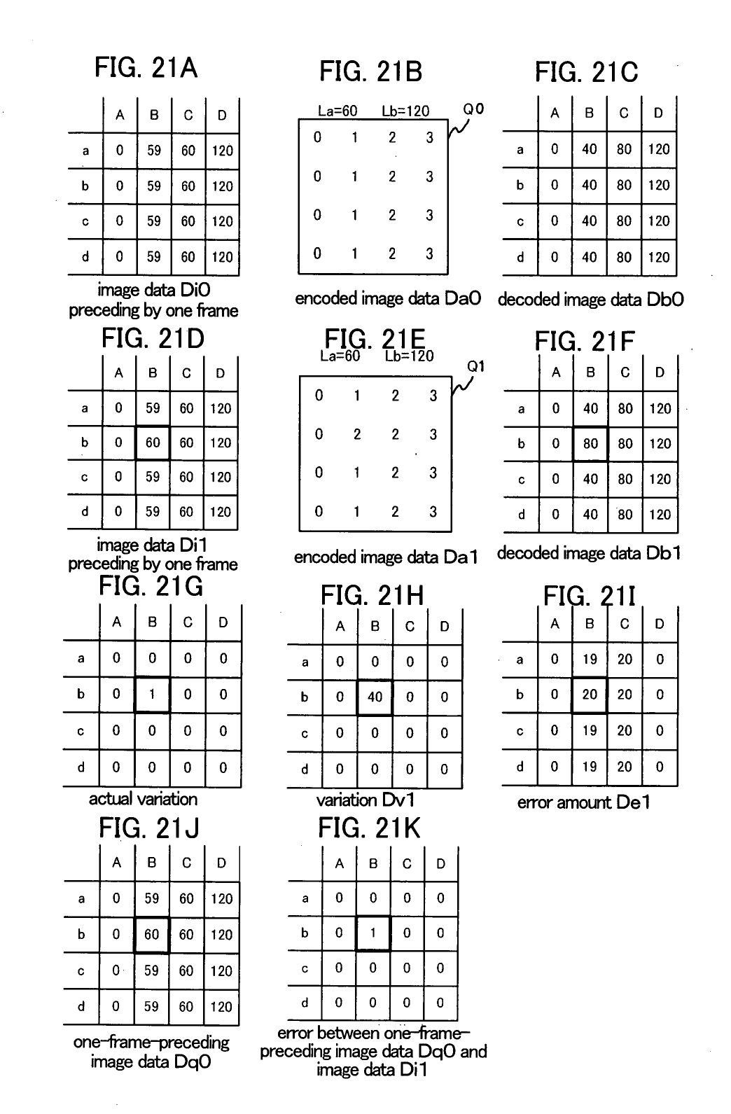

FIG. 21 are diagrams for explaining processes of generating the one-frame-preceding image data D_{q0} when a still image with pseudo gray-scale signals added by a dither processing is inputted. In the following explanations, the predetermined threshold SH₀ used in generating the one-frame-preceding image data D_{q0} is SH₀=8.

FIGS. 21D and 21A indicate values of the image data Dᵢ₁ of a current frame and the image data Dᵢ₀ preceding by one frame, respectively. As shown in FIG. 21D, a pixel data (b, B) in the image data Dᵢ₁ of the current frame varies 59 to 60 after being added with a pseudo gray-scale signal by the dither processing.

FIGS. 21E and 21B indicate encoded data encoded by FBTC from the image data Dᵢ₁ of the current frame and the image data Dᵢ₀ preceding by one frame. Here, the averaged value Lₐ and the dynamic range L_{b} of each of the blocks are represented by 8 bit data, and quantization is performed by assigning 2 bits to each pixel.

FIGS. 21F and 21C indicate the decoded image data D_{b1} of the current frame and the decoded image data D_{b0} preceding by one frame, both obtained by decoding the encoded data shown in FIGS. 21E and 21B, respectively. While the image data Dᵢ₁ and corresponding decoded image data D_{b1} are 59 and 40, respectively, the image data Dᵢ₁ and corresponding decoded image data D_{b1} in the pixel (b, B), where a pseudo gray-scale signal is added, are 60 and 80, respectively, as shown in FIGS. 21D and 21F.

FIG. 21G indicates a difference between the image data Dᵢ₀ and Dᵢ₁ shown in FIGS. 21A and 21D, actual variations of the image. FIG. 21H indicates the variation Dᵥ₁ that represents absolute values of the differences between the decoded image data D_{b0} and D_{b1} shown in FIGS. 21C and 21F. As shown in FIG. 21G, while a difference between the image data Dᵢ₀ and Dᵢ₁ in the pixel data (b, B) is 1, the variation Dᵥ₁, a difference between the decoded image data D_{b0} and D_{b1}, in the same pixel is 40 due to the encoding and decoding error.

FIG. 21I indicates the error amount Dₑ₁ that represents absolute value of difference between the image data Dᵢ₁ of the current frame shown in FIG. 21D and the decoded image data D_{b1} of the current frame shown in FIG. 21F.

FIG. 21J indicates the one-frame-preceding image data D_{q0} generated by selecting the image data Dᵢ₁ or the decoded image data D_{b0} shown in FIGS. 21D and 21C, respectively, on a pixel to pixel basis based on the variation Dᵥ₁ shown in FIG. 21H and the error amounts Dₑ₁ shown in FIG. 21I. Since the variation Dᵥ₁ are all 0 in pixels except for the pixel (b, B) as shown in FIG. 21H, the one-frame-preceding-image calculation unit 10 selects the image data Dᵢ₁ as one-frame-preceding image data for the pixels except for the pixel (b, B). On the other hand, since a value of the variation Dᵥ₁ of the pixel (b, B) is larger than the threshold SH₀, and the value of the variation Dᵥ₁ (=40) is equal to two times of the corresponding value of the error amounts Dₑ₁ (=20), the one-frame-preceding-image calculation unit 10 selects the image data Dᵢ₁ as a one-frame-preceding data for the pixel (b, B).

FIG. 21K indicates an error between the one-frame-preceding image data D_{q0} and the image data Dᵢ₀ preceding by one frame. As shown in FIG. 21K, an error in the pixel (b, B) added with a pseudo gray-scale signal by the dither processing is 1. This means the influence of the encoding and decoding error is prevented.

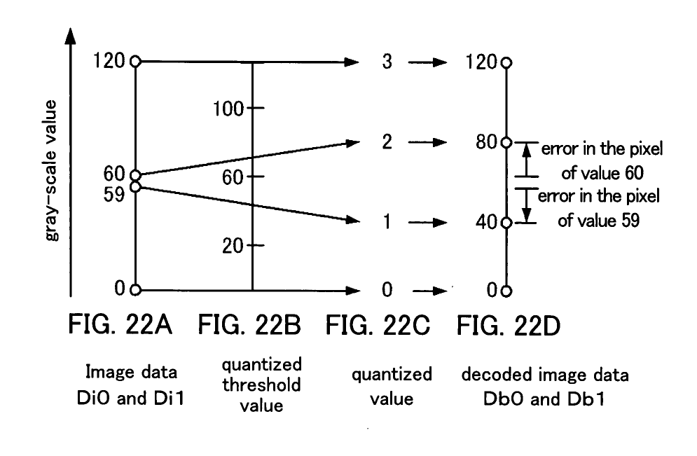

FIG. 22 are diagrams for explaining the encoding and decoding error shown in FIG. 21.

FIG. 22A indicates gray-scale values of the image data Dᵢ₀ and Dᵢ₁ represented by 8 bit data. FIG. 22B indicates quantizing thresholds for the image data Dᵢ₀ and Dᵢ₁. FIG. 22C indicates quantized values of the image data Dᵢ₀ and Dᵢ₁ shown in FIG. 22A obtained by quantizing these data into 2 bit data using the quantizing thresholds shown in FIG. 22B. FIG. 22D indicates gray-scale values of the decoded image data D_{b0} and D_{b1} obtained by decoding these data into 8 bit data using the quantized values shown in FIG. 22C.

Since the image data Dᵢ₀ and Dᵢ₁ are quantized using the thresholds of 20, 60, and 100 as shown in FIG. 22B, quantized values corresponding to gray-scale values of 0, 59, 60, and 120 are 0, 1, 2, and 3, respectively, as shown in FIG. 22C. When the quantized values shown in FIG. 22C are decoded, the gray-scale values of 0, 59, 60, and 120 in the image data Dᵢ₀ and Dᵢ₁ are converted into 0, 40, 80, and 120, respectively, as shown in FIG. 22D. As indicated by this example, when such two gray-scale values as 59 and 60 in the image data Dᵢ₀ and Dᵢ₁, one of which is equal to or larger than the quantizing threshold and the other one is smaller than the quantizing threshold, are decoded, these values are converted into 40 and 80, respectively, while an actual variation is 1. As a result, corresponding value of the variation Dᵥ₁ obtained from the decoded image data D_{b0} and D_{b1} becomes 40, producing large error.

As previously explained, the one-frame-preceding-image calculation unit 10 generates the one-frame-preceding image data D_{q0} by selecting the image data Dᵢ₁ as image data preceding by one frame for pixels of which variations Dᵥ₁ are larger than the predetermined threshold SH₀ and equal to two times of the error amounts Dₑ₁, and selecting the decoded image data D_{b0} as image data preceding by one frame for pixels of which variations Dᵥ₁ are larger than the threshold SH₀ and not equal to two times of the error amounts Dₑ₁. Accordingly, since the pixel (b, B) in the image data Dᵢ₁ shown in FIG. 21D is regarded as representing a still image, the image data Dᵢ₁ is selected as image data preceding by one frame. Therefore, the one-frame-preceding image data Dᵢ₀ can be correctly generated without affected by the error in the variation Dᵥ₁ caused by the encoding and decoding error. This means, even in case that image data Dᵢ₁ added with pseudo gray-scale signals are inputted, the one-frame-preceding image data D_{q1} can be generated without affected by the encoding and decoding error.

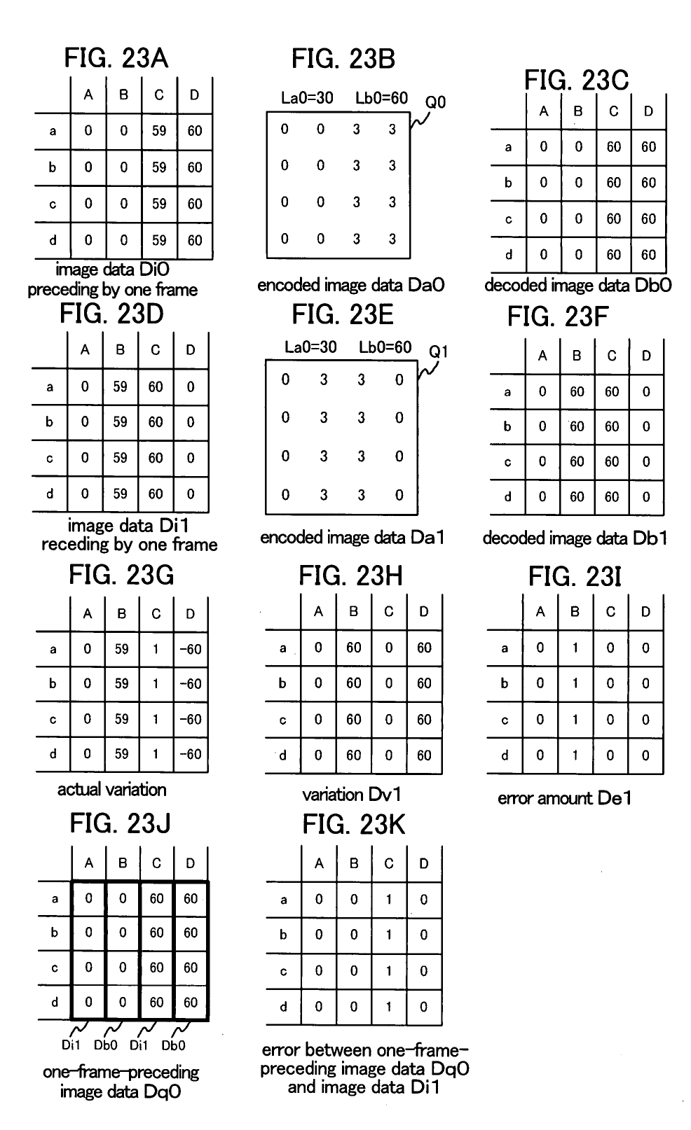

FIG. 23 are diagrams for explaining processes of generating the one-frame-preceding image data D_{q0} when a motion image is inputted. In the following explanations, the predetermined threshold SH₀ used in generating the one-frame-preceding image data D_{q0} is SH₀=8.

FIGS. 23D and 23A indicate values of the image data Dᵢ₁ of a current frame and the image data Dᵢ₀ preceding by one frame, respectively. Comparing the image data Dᵢ₀ with Dᵢ₁ shown in FIGS. 23A and 23D, pixel data in the B, C and D columns vary from 0 to 59, 59 to 60 and 60 to 0.

FIGS. 23B and 23E indicate encoded data obtained by encoding the image data Dᵢ₀ preceding by one frame and the image data Dᵢ₁ of the current frame using FBTC.

FIGS. 23C and 23F indicate the decoded image data D_{b0} preceding by one frame and the image data D_{b1} of the current frame obtained by decoding the encoded data shown in FIGS. 23B and 23E.

FIG. 23G indicates a difference between the image data Dᵢ₀ and Dᵢ₁ shown in FIGS. 23A and 23D, actual variations of the image. FIG. 23H indicates the variation Dᵥ₁ representing absolute values of a difference between the decoded image data D_{b0} and D_{b1} shown in FIGS. 23C and 23F.

FIG. 23I indicates error amounts Dₑ₁ that are absolute values of differences between the image data Dᵢ₁ of the current frame shown in FIG. 23D and the decoded image data D_{b1} of the current frame shown in FIG. 23F.

FIG. 23J indicates the one-frame-preceding image data D_{q0} generated by selecting the image data Dᵢ₁ or the decoded image data D_{b0} shown in FIGS. 23D and 23C on a pixel to pixel basis, based on the variation Dᵥ₁ shown in FIG. 23H and the error amounts Dₑ₁ shown in FIG. 23I. The variation Dᵥ₁ in the B and D columns is 60, exceeding the threshold (SH₀=8), and not equal to two times of the error amounts Dₑ₁. The variation Dᵥ₁ in A and C columns is 0, equal to or smaller than the threshold. Accordingly, the one-frame-preceding-image calculation unit 10 generates the one-frame-preceding image data D_{q0} by selecting the image data Dᵢ₁ of the current frame for pixels in the A and C columns and selecting the decoded image data D_{b0} for pixels in the B and D columns.

FIG. 23K indicates an error between the one-frame-preceding image data D_{q0} and the image data Dᵢ₀ preceding by one frame.

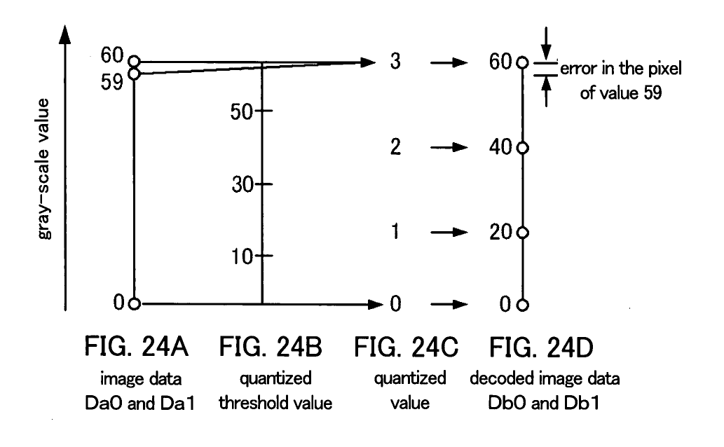

FIG. 24 are diagrams for explaining the encoding and decoding error shown in FIG. 23.

FIG. 24A indicates gray-scale values of the image data Dᵢ₀ and Dᵢ₁ represented by 8 bit data. FIG. 24B indicates quantizing thresholds used for quantizing the image data Dᵢ₀ and Dᵢ₁. FIG. 24C indicates quantized values of the image data Dᵢ₀ and Dᵢ₁ shown in FIG. 24A obtained by quantizing these data into 2 bit data using the quantizing thresholds shown in FIG. 24B. FIG. 24D indicates gray-scale values of the decoded image data D_{b0} and D_{b1} obtained by decoding these data into 8 bit data using the quantized values shown in FIG. 24C.

Since the image data Dᵢ₀ and Dᵢ₁ are quantized using the thresholds of 10, 30, and 50 as shown in FIG. 24B, quantized values corresponding to gray-scale values of 0, 59, and 60 are 0, 60, and 60, respectively, as shown in FIG. 24C. When the quantized values shown in FIG. 24C are decoded, the gray-scale values of 0, 59, and 60 in the image data Dᵢ₀ and Dᵢ₁ are converted into 0, 60, and 60, respectively, as shown in FIG. 24D. As a result, when the gray-scale values of 59 and 60 in the image data Dᵢ₀ and Dᵢ₁ are decoded, both of these data are converted into 60, producing an error equivalent to one level in gray-scale.

As previously explained, the one-frame-preceding-image calculation unit 10 generates the one-frame-preceding image data D_{q0} by selecting the image data Dᵢ₁ as image data preceding by one frame for pixels of which variation Dᵥ₁ is smaller than the predetermined threshold SH₀, and selecting the decoded image data D_{b0} as image data preceding by one frame for a pixel of which variation Dᵥ₁ is larger than the threshold SH₀ and not equal to two times of the error amounts Dₑ₁. Therefore, even in case that a motion image is inputted, the one-frame-preceding image data Dᵢ₀ can be correctly generated without affected by the encoding and decoding error.

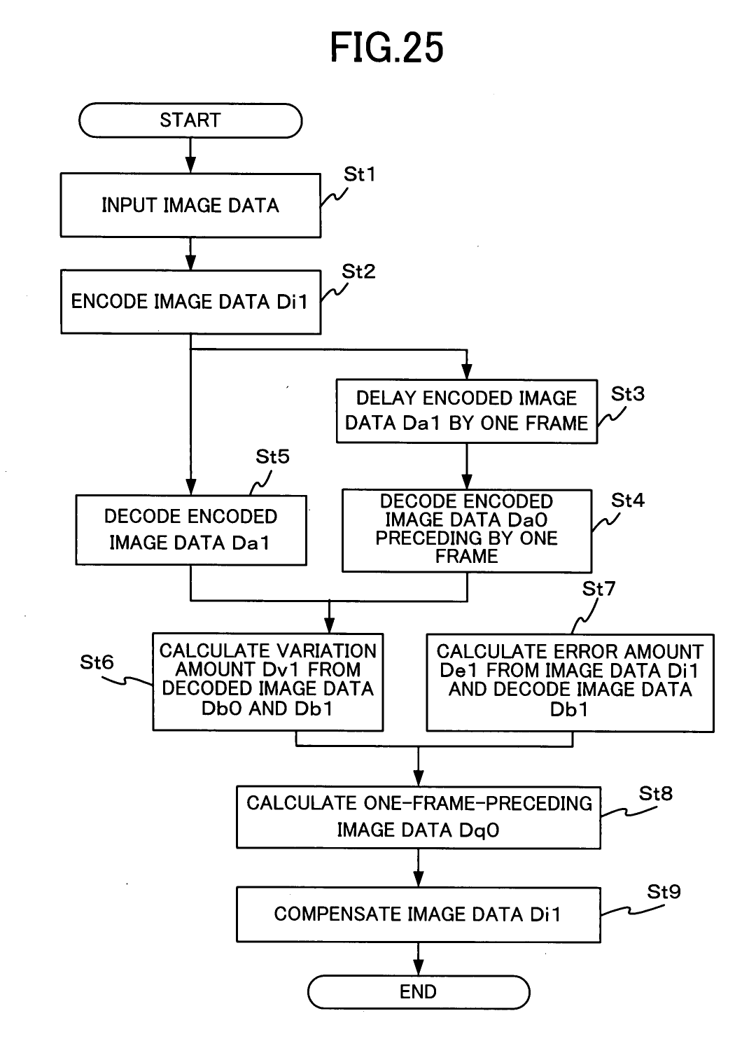

FIG. 25 is a block diagram illustrating the above-explained processing steps executed by the image data processing unit 3 in the image processor according to this invention.

First, the image data Dᵢ₁ is inputted into the image data processing unit 3 (St1). The encoding unit 4 encodes the image data Dᵢ₁ inputted thereto and outputs the encoded image data Dₐ₁ (St2). The delay unit 5 delays the encoded image data Dₐ₁ for one frame period, and output the encoded image data Dₐ₀ preceding by one frame (St3). The decoding unit 7 decodes the encoded image data Dₐ₀ and outputs the decoded image data D_{b0} corresponding to the image data Dᵢ₀ preceding by one frame (St4). In parallel with these processing, the decoding unit 6 decodes the encoded image data Dₐ₁, and output the decoded image data D_{b1} corresponding to the image data Dᵢ₁ of a current frame (St5).

The variation calculation unit 8 calculates differences between the decoded image data D_{b1} of the current frame and the image data D_{b0} preceding by one frame on a pixel to pixel basis, and output the differences as the variation Dᵥ₁. (St6). In parallel with this process, the error amount calculation unit 13 calculates differences between the decoded image data D_{b1} of the current frame and the image data Dᵢ₁ of the current frame, and output a difference as the error amount Dₑ₁ (St7).

The one-frame-preceding-image calculation unit 10 generates the one-frame-preceding image data D_{q0} by selecting the image data Dᵢ₁ of the current frame as image data preceding by one frame for a pixel of which variation Dᵥ₁ is smaller than the predetermined threshold SH₀ and for a pixel of which variation Dᵥ₁ is larger than the predetermined threshold SH₀ and equal to two times of the error amounts Dₑ₁, and selecting the decoded image data D_{b0} preceding by one frame as image data preceding by one frame for a pixel of which absolute values of the variation Dᵥ₁ is larger than the predetermined threshold SH₀ and not equal to two times of the error amounts Dₑ₁, (St8).

The image data compensation unit 11 compares the one-frame-preceding image data D_{q0} with the image data Dᵢ₀ and calculates compensation amounts necessary for driving the liquid crystal to reach predetermined transmittances designated by the image data Dᵢ₁ within one frame period based on changes in the gray-scale values. Then, the image data compensation unit 11 compensates the image data Dᵢ₁ using the compensation amounts and output the compensated image data Dⱼ₁ (St9).

The processing steps St1 through St9 are executed for each pixel of the image data Dᵢ₁.

As explained above, an image processor according to the present invention selects the image data Dᵢ₁ as image data preceding by one frame for a pixel of which variation Dᵥ₁ of the decoded image data D_{b0} and D_{b1} is smaller than the predetermined threshold SH₀, regarding this pixel as a still image. As for a pixel of which variation Dᵥ₁ is larger than the threshold SH₀, the image data D11 is selected when the variation Dᵥ₁ is equal to two times of the error amount Dₑ₁, regarding this pixel as a motion image, and the encoded image data D_{b0} is selected when the variation Dᵥ₁ is not equal to two times of the error amounts Dₑ₁, regarding this pixel as a motion the image. As shown in FIG. 21, even when the image data Dᵢ₁ and Dᵢ₀ that include gray-scale values one of which is equal to or larger than a quantizing threshold and the other one is smaller than the this quantizing threshold are inputted, the one-frame-preceding image data D_{q0}. can be generated without affected by the encoding and decoding error. Therefore, even in cases that image data added with pseudo gray-scale signals are inputted, the appropriate compensation voltages can be applied to the liquid crystal.

The one-frame-preceding image data D_{q0} may be calculated by the following Formula (3):

D_{q0}=k₁×k₂×D_{b0}+(1−k₁×k₂)×Dᵢ₁ (3).

In Formula (3) above, k₁ is a coefficient that varies depending on the variation Dᵥ₁, and k₂ is a coefficient that varies depending on the variation Dᵥ₁ and the control signal D_{w1}.

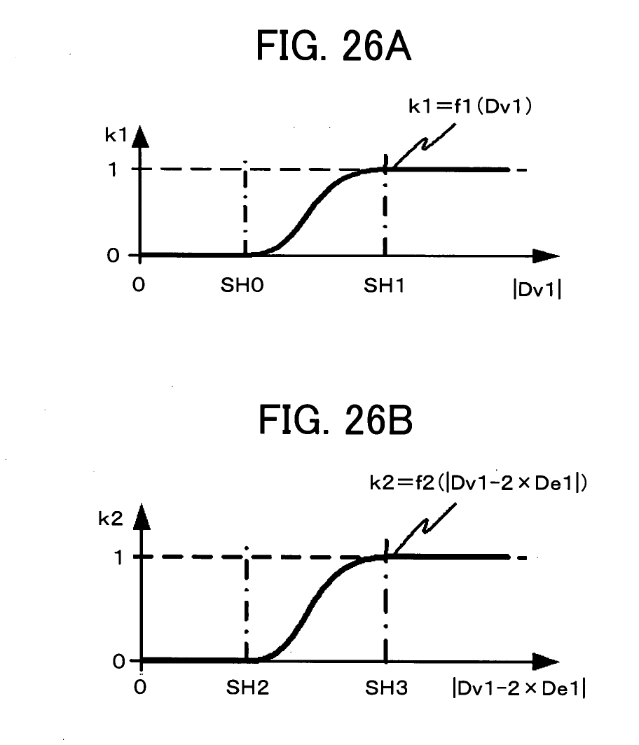

FIG. 26A is a graph illustrating a relationship between the coefficient k₁ and the variation Dᵥ₁. FIG. 26B is a graph illustrating a relationship between the coefficient k₂, and the variation Dᵥ₁ and the error amounts Dₑ₁. As shown in FIG. 26A, the two thresholds SH₀ and SH₁ (SH₀<SH₁) are set for the absolute values of the variation Dᵥ₁; k₁=0 when |Dᵥ₁|<SH₀; k₁, 0≦k₁≦1 when SH₀≦|Dᵥ₁|≦SH₁, and k₁=1 when SH₁<|Dᵥ₁|. As shown in FIG. 26B, the two thresholds SH₂ and SH₃ (SH₂<SH₃) are also set for a differences between the variation Dᵥ₁ and two times of the error amounts Dₑ₁(|Dᵥ₁−2×Dₑ₁|); k₂=0 when |Dᵥ₁−2×Dₑ₁|<SH₂, 0≦k₂≦1 when SH₂≦|Dᵥ₁−2×Dₑ₁|≦SH₃, and k₂=1 when SH₃<|Dᵥ₁−2×Dₑ₁|.

As shown in Formula (3), when either k₁ or k₂ is 0, the image data Dᵢ₁ is selected as the one-frame-preceding image data D_{q}, and when both k₁ and k₂ are 1, the decoded image data D_{b0} is outputted as the one-frame-preceding image data D_{q0}. In case other than above, weighted averages of the image data Dᵢ₁ and the decoded image data D_{b0} are calculated as the one-frame-preceding image data D_{q}, based on the product of k₁ and k₂.

By using Formula (3), the one-frame-preceding image data D_{q1} varies continuously between the image data Dᵢ₁ and the decoded image data D_{b0} depending on the variation Dᵥ₁, thereby preventing a motion image region from changing abruptly.

1. An image processor that corrects image data representing a gray-scale value of each of pixels of an image, based on a change in the gray-scale value of each pixel, the image processor comprising:
an encoding means for dividing a current-frame image into a plurality of blocks and outputting first encoded image data, corresponding to the current-frame image, the first encoded image data including a representative value denoting a magnitude of pixel data of each of the blocks and a quantized value of pixel data in each of the blocks, the quantized value being obtained by quantizing the pixel data in each blocks based on the representative value;
a decoding means for decoding the first encoded image data thereby outputting first decoded image data corresponding to the current-frame image;
a delay means for delaying the first encoded image data for a period equivalent to one frame, thereby outputting second encoded image data corresponding to the image preceding the current frame by one frame;
a decoding means for decoding the second encoded image data, thereby outputting second decoded image data corresponding to the image preceding the current frame by one frame;
an encoded data discrimination means for calculating variations of the representative value and the quantized value between the current-frame image and the image preceding by one frame, by referring to the first and the second encoded image data, and generating a control signal denoting a change in the pixel data of the current frame in each of the blocks, based on these variations;
a one-frame-preceding-image calculation means for generating one-frame-preceding image data by selecting the current-frame image data or the second decoded image data on a pixel to pixel basis, based on the control signal; and
an image data compensation means for compensating a gray-scale value of the current-frame image, based on the current-frame image data and the one-frame-preceding image data.

2. The image processor as recited in claim 1, wherein:
said encoding means uses an averaged value of pixel data and a dynamic range in each of the blocks as the representative values; and
said discrimination means calculates the variations of the averaged value and the dynamic range as the variations of the representative values.

3. The image processor as recited in claim 1, wherein:
said encoded data discrimination means outputs a first control signal defining a pixel as a still image for a pixel of which variation of the quantized value is 0 or one and a second control signal defining a pixel as a motion image for a pixel of which variation of the quantized value exceeds 1, in a block where the variation of the representative value is smaller than a predetermined threshold; and
said one-frame-preceding-image calculation means generates the one-frame-preceding image data by selecting the current-frame image data for a pixel where the first control signal is outputted and selecting the second decoded image data for a pixel where the second control signal is outputted for.

4. The image processor as recited in claim 3, wherein said encoded data discrimination means outputs the second control signal defining a pixel as a motion image, for all pixels in a block of which variation of the representative value is larger than the predetermined threshold.

5. The image processor as recited in claim 1, further comprising
a variation calculation means for calculating a variation between the first and the second decoded image data on a pixel to pixel basis, wherein:
said encoded data discrimination means outputs a first control signal defining a pixel as a still image for a pixel of which variation of the quantized value is 0 or 1 and a second control signal defining a pixel as a motion image for a pixel of which variation of the quantized value exceeds one, in a block where the variation of the representative value is smaller than a predetermined threshold; and
said one-frame-preceding-image calculation means generates the one-frame-preceding image data by selecting the current-frame image data for a pixel, the variation of which is smaller than a predetermined threshold, and for a pixel where the first control signal is outputted, and selecting the second decoded image data for a pixel, the variation of which exceeds the predetermined threshold, where the second control signal is outputted.

6. The image processor as recited in claim 5, wherein the encoded data discrimination means outputs the second control signal defining a pixel as a motion image, for all pixels in a block where the variation of the representative value is larger than a predetermined threshold.

7. The image processor as recited in claim 1, further comprising a variation calculation means for calculating a variation between the first and the second decoded image data on a pixel to pixel basis, wherein:
the encoded data discrimination means outputs a first control signal defining a pixel as a still image for a pixel of which variation of the quantized value is 0 or 1 and a second control signal defining a pixel as a motion image for a pixel of which variation of the quantized value exceeds 1, in a block where the variation of the representative value is smaller than a predetermined threshold; and
the one-frame-preceding image calculation means generates the one-frame-preceding image data by selecting the current-frame image data for a pixel, the variation of which is smaller than a first threshold, and for a pixel where the first control signal is outputted, selecting the second decoded image data for a pixel, the variation of which exceeds a second threshold, where the second control signal is outputted, and selecting a weighted averaged value of the current-frame image data and the second decoded image data for a pixel, the variation of which is a value between the first and the second thresholds, where the second control signal is outputted.

8. An image display device comprising the image processor recited in claim 1.

9. An image processing method for correcting image data representing a gray-scale value of each of pixels of an image, based on a change in the gray-scale value of each pixel, the image processing method comprising:
a step of dividing a current-frame image into a plurality of blocks, thereby outputting first encoded image data, corresponding to the current-frame image, the first encoded image data including a representative value denoting a magnitude of pixel data of each of the blocks, and a quantized value obtained by quantizing the pixel data in each of the blocks based on the representative value;
a step of decoding the first encoded image data, thereby outputting first decoded image data corresponding to the current-frame image;
a step of delaying the first encoded image data for a period equivalent to one frame, thereby outputting second encoded image data corresponding to the image preceding the current frame by one frame;
a step of decoding the second encoded image data, thereby outputting second decoded image data corresponding to the image preceding the current frame by one frame;
a step of calculating variations of the representative value and of the quantized value between the current-frame image and the image preceding by one frame, by referring to the first and the second encoded image data, and generating a control signal denoting a change in the pixel data of the current frame in each of the blocks, based on these variations;
a step of generating one-frame-preceding image data by selecting the current-frame image data or the second decoded image data on a pixel to pixel basis, based on the control signal; and
a step of compensating a gray-scale value of the current-frame image, based on the current-frame image data and the one-frame-preceding image data.

10. The image processing method as recited in claim 9, wherein an averaged value of pixel data and a dynamic range of each of the blocks are used as representative values, and variations of the averaged value and the dynamic range are calculated as variations of the representative values.

11. The image processing method as recited in claim 9, wherein, in a block of which change in the representative value is smaller than a predetermined threshold, a first control signal defining a pixel as a still image is outputted for a pixel of which variation of the quantized value is 0 or 1, and a second control signal defining a pixel as a motion image is outputted for a pixel of which variation of the quantized value exceeds 1; and
the one-frame-preceding image data is generated by selecting the current-frame image data for a pixel that the first control signal is outputted for, and selecting the second decoded image data for a pixel that the second control signal is outputted for.

12. The image processing method as recited in claim 10, wherein the second control signal defining a pixel as a motion image is outputted for all pixels in a block of which change in the representative value is larger than the predetermined threshold.

13. The image processing method as recited in claim 9, further comprising a step of calculating a variation between the first and the second decoded image data on a pixel to pixel basis, wherein, in a block of which change in the representative value is smaller than a predetermined threshold,
a first control signal defining a pixel as a still image is outputted for a pixel of which variation of the quantized value is 0 or 1, and a second control signal defining a pixel as a motion image is outputted for a pixel of which variation of the quantized value exceeds 1; and
the one-frame-preceding image data is generated by selecting the current-frame image data for a pixel of which variation is smaller than a predetermined threshold and for a pixel that the first control signal is outputted for, and selecting the second decoded image data for a pixel of which variation exceeds the predetermined threshold and for which the second control signal is outputted.

14. The image processing method as recited in claim 13, wherein the second control signal is outputted for all pixels in a block of which change in the representative value is larger than a predetermined threshold.

15. The image processing method as recited in claim 9, further comprising a step of calculating a variation between the first and the second decoded image data on a pixel to pixel basis, wherein, in a block of which change in the representative value is smaller than a predetermined threshold,
a first control signal defining a pixel as a still image is outputted for a pixel of which variation of the quantized value is 0 or 1, and a second control signal defining a pixel as a motion image is outputted for a pixel of which variation of the quantized value exceeds 1; and
the one-frame-preceding image data is generated by selecting the current-frame image data for a pixel of which variation is smaller than a first threshold and for a pixel that the first control signal is outputted for, selecting the second decoded image data for a pixel of which variation exceeds a second predetermined threshold and for which the second control signal is outputted, and selecting a weighted averaged value of the current-frame image data and the second decoded image data for, a pixel of which variation is between the first and the second thresholds and for which the second control signal is outputted.

16. An image processor that corrects image data representing a gray-scale value of each of pixels of an image, based on a change in the gray-scale value of each pixel, the image processor comprising:
an encoding means for encoding image data representing a current-frame image thereby outputting the encoded image data corresponding to the current-frame image;
a decoding means for decoding the encoded image data thereby outputting first decoded image data corresponding to the current-frame image data;
a delay means for delaying the encoded image data for a period equivalent to one frame;
a decoding means for decoding the encoded image data outputted from said delay means thereby outputting second decoded image data corresponding to the image data preceding the current frame by one frame;
a means for calculating a variation between the first and the second decoded image data and an error amount between the current-frame image data and the first decoded image data on a pixel to pixel basis, and generating one-frame-preceding image data by selecting either the current-frame image data or the second decoded image data on a pixel to pixel basis, based on the variation and the error amount; and
an image data compensation means for compensating a gray-scale value of the current-frame image, based on the one-frame-preceding image data and the current-frame image data.

17. The image processor as recited in claim 16, wherein said means for generating one-frame-preceding image data generates the one-frame-preceding image data by selecting the current-frame image data for a pixel, the variation of which is smaller than a predetermined threshold, and for a pixel, the variation of which is larger than the threshold and equal to two times of the error amount, and selecting the second decoded image data for a pixel, the variation of which is larger than the threshold and not equal to two times of the error amount.

18. The image processor as recited in claim 16, wherein said means for generating one-frame-preceding image data generates the one-frame-preceding image data by comparing the variation with a first and a second thresholds and comparing an absolute difference value between the variation and two times of the error amount with a third and a forth thresholds, and by selecting the current-frame image data for a pixel, the variation of which is smaller than the first threshold, and for a pixel, the variation of which is larger than the second threshold and the absolute difference value of which is smaller than the third threshold, selecting the second decoded image data for a pixel, the variation of which is larger than the second threshold and the absolute difference value of which is larger than the forth threshold, and selecting a weighted average value of the current-frame image data and the second decoded image data for the other pixels.

19. An image display device comprising the image processor recited in claim 16.

20. An image processing method for correcting image data representing a gray-scale value of each of pixels of an image, based on a change in a gray-scale value of each pixel, the image processing method comprising the steps of
encoding image data representing a current-frame image, thereby outputting the encoded image data corresponding to the current-frame image;
decoding the encoded image data, thereby outputting first decoded image data corresponding to the current-frame image data;
delaying the encoded image data for a period equivalent to one frame, thereby outputting second decoded image data corresponding to the image data preceding the current frame by one frame;
calculating a variation between the first and the second decoded image data and an error amount between the current-frame image data and the first decoded image data on a pixel to pixel basis,
generating one-frame-preceding image data by selecting the current-frame image data or the second decoded image data on a pixel to pixel basis based on the variations and the error amounts, either; and
compensating a gray-scale value of the current-frame image, based on the one-frame-preceding image data and the current-frame image data.

21. The image processing method as recited in claim 20, wherein the one-frame-preceding image data is generated by selecting the current-frame image data for a pixel of which variation is smaller than a predetermined threshold and for a pixel of which variation is larger than the threshold and equal to two times of the error amount, and selecting the second decoded image data for a pixel of which variation is larger than the threshold and not equal to twice of the error amount.

22. The image processing method as recited in claim 20, further comprising:
comparing the variation with a first and a second thresholds,
comparing an absolute difference value between the variation and two times of the error amount with a third and a forth thresholds,
wherein the one-preceding-frame image data is generated by selecting the current-frame image data for a pixel of which variation is smaller than the first threshold and for a pixel of which variation is larger than the second threshold and of which absolute difference value is smaller than the third threshold, selecting the second image data for a pixel of which variation is larger than the second threshold and of which absolute difference value is larger than the forth threshold, and selecting a weighted averaged value of the current-frame image data and the second decoded image data for the other pixels.
